(19) United States
(12) Patent Application Publication
(10) Pub. No.: US 2010/0241543 A1
(43) Pub. Date: Sep. 23, 2010

(54) IMAGE FORMATION SYSTEM, IMAGE FORMATION DEVICE, AND METHOD OF BILLING CALCULATION

(75) Inventor: Yukinori MATSUMOTO, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/725,818

(22) Filed: Mar. 17, 2010

(30) Foreign Application Priority Data
Mar. 18, 2009 (JP) 2009-065474

(51) Int. Cl. G06Q 30/00; G06F 3/12; G06Q 10/00; G06Q 50/00

(52) U.S. Cl. 705/34; 358/1.15; 705/400

(57) ABSTRACT

An image formation device includes: a job execution control part for controlling execution of a job; a storage part for storing therein a billing map to be used for billing calculation in response to execution of the job; a billing calculation part for performing billing calculation by referring to the billing map stored in the storage part, the billing calculation being performed in response to execution of the job by the job execution control part; and a billing map switching part for changing a billing map to be referred to by the billing calculation part when the progress of the job executed by the job execution control part satisfies a predetermined condition. So, the substance of billing calculation can be changed when the progress of a job satisfies the predetermined condition during execution of the job.

This application is based on the application No. 2009-065474 filed in Japan, the contents of which are hereby incorporated by reference.

### BACKGROUND OF THE INVENTION

1. Field of the Invention

The present invention relates to an image formation system, an image formation device, and a method of billing calculation.

2. Description of the Background Art

A conventional image formation device called by a name such as a complex device or an MFP (multifunction peripheral) holds billing information used to make billing in response to execution of a job. When a user logs in to the image formation device to provide instructions to execute a job, the image formation device performs billing calculation based on the billing information in response to execution of the job, and bills login user.

In such an image formation device, it is assumed that there is a need to bill a specially authorized user at a higher discount than other users when the specially authorized user performs printing, for example. In order to satisfy this need, according to a known technique introduced for example in Japanese Patent Application Laid-Open No. 2005-238717, the image formation device acquires billing information corresponding to a user who has been authorized by an IC card, and sets a billing rate for a specific function when used by the user. This technique allows a billing rate to be for each specific function available for the user.

In the image formation device that performs billing calculation in response to execution of a job, an example of a need is such that, when the number of printed sheets produced reaches or exceeds a predetermined number during execution of the job, calculation of billing for subsequent printing is preferably performed at a discount.

However, the conventional image formation device acquires billing information at the time of user's login, and cannot change the acquired billing information before user's logout. Thus, billing calculation during execution of a job is based on the billing information acquired at the time of the user's login, so a discount cannot be made even when the number of printed sheets produced by executing the job exceeds a predetermined number.

The change of unit price information applied as a basis for billing calculation, which is not limited to making of a discount, may be desirable when the progress of a job reaches a set value of a predetermined condition. However, failing to change billing information during execution of the job, the conventional image formation device cannot perform billing calculation that meets such a desire.

### SUMMARY OF THE INVENTION

The present invention has been made in order to solve the above-described problems. The present invention is intended to provide an image formation system, an image formation device, and a method of billing calculation in which the substance of billing calculation is changed when the progress of a job satisfies a predetermined condition during execution of the job, so that the above-described needs can be met.

First, the present invention is intended for an image formation system.

The image formation system according to one aspect of the present invention comprises an image formation device and a management server connected through a network in a manner that allows data communication with each other. The management server includes: a storage part for storing therein billing map information to be referred to for billing calculation in response to execution of a job in the image formation device; and a billing map transmission part for reading a billing map to be transmitted to the image formation device that is one of a plurality of billing maps contained in the billing map information, and for transmitting the read billing map to the image formation device. The image formation device includes: a billing map acquisition part for acquiring the billing map transmitted from the management server; a job execution control part for controlling execution of a job; a billing calculation part for performing billing calculation by referring to the billing map acquired by the billing map acquisition part, the billing calculation being performed in response to execution of the job by the job execution control part; and a billing map switching part for changing the billing map to be referred to by the billing calculation part when the progress of the job executed by the job execution control part satisfies a predetermined condition.

The image formation system according to another aspect of the present invention comprises a first image formation device, a second image formation device, and a management server connected through a network in a manner that allows data communication with each other. Each of the first and second image formation devices includes: a billing map acquisition part for acquiring a billing map transmitted from the management server through the network; a billing calculation part for performing billing calculation based on the billing map in response to execution of a job; and a job progress notification part for notifying the management server of the progress of the job. The management server includes: a billing map transmission part for transmitting a basic billing map to each of the first and second image formation devices, the basic billing map being used for billing calculation at an initial stage of execution of a job; and a billing map switching determination part for determining, after transmission of the basic billing map, whether or not the respective progresses of two or more jobs executed in the first and second image formation devices satisfy a predetermined condition based on the respective progresses of the jobs notified both from the first and second image formation devices. The billing map transmission part transmits a replacement billing map to take the place of the basic billing map to each of the first and second image formation devices based on a result of the determination made by the billing map switching determination part.

Second, the present invention is intended for an image formation device.

The image formation device according to an aspect of the present invention comprises: a job execution control part for controlling execution of a job; a storage part for storing therein a billing map to be used for billing calculation in response to execution of the job; a billing calculation part for performing billing calculation by referring to the billing map stored in the storage part in response to execution of the job by the job execution control part; and a billing map switching part for changing the billing map to be referred to by the billing calculation part when the progress of the job executed by the job execution control part satisfies a predetermined condition.

Third, the present invention is intended for a method of billing calculation in an image formation device.

The method of billing calculation according an aspect of the present invention is performed in response to execution of a job in the image formation device, and comprises the steps of: acquiring a basic billing map and a replacement billing map before execution of a job, the basic billing map being used for billing calculation at an initial stage of execution of the job, the replacement billing map being used for billing calculation at a stage at which the progress of the job satisfies a predetermined condition; starting execution of the job; performing billing calculation based on the basic billing map in response to execution of the started job; changing the billing map to be referred to for the billing calculation from the basic billing map to the replacement billing map when the progress of the job satisfies the predetermined condition; and after the progress of the job satisfies the predetermined condition, performing billing calculation based on the replacement billing map in response to execution of the job.

### BRIEF DESCRIPTION OF THE DRAWINGS

FIG. 1 shows an exemplary configuration of an image formation system according to a preferred embodiment of the present invention;

FIG. 2 is a block diagram showing an exemplary hardware configuration of an image formation device;

FIG. 3 is a block diagram showing an exemplary functional configuration realized by a control computer of the image formation device;

FIG. 4 is a block diagram showing an exemplary hardware configuration of a management server;

FIG. 5 is a block diagram showing an exemplary functional configuration realized by a CPU of the management server;

FIG. 6 shows an example of a basic billing map of a first preferred embodiment of the present invention;

FIG. 7 shows an example of a first replacement billing map of the first preferred embodiment;

FIG. 8 explains the general outlines of processes performed by the image formation device and the management server in the first preferred embodiment;

FIG. 9 is a flow diagram explaining an exemplary procedure of a process performed by the image formation device in the first preferred embodiment;

FIG. 10 shows an example of billing map information stored in a storage part of the management server in a second preferred embodiment of the present invention;

FIG. 11 shows an example of a basic billing map of the second preferred embodiment;

FIG. 12 shows an example of a first condition billing map of a first replacement billing map of the second preferred embodiment;

FIG. 13 shows an example of a second condition billing map of the first replacement billing map of the second preferred embodiment;

FIG. 14 explains an idea on how to rewrite a billing map in order to change a billing map to be referred to for billing calculation in the image formation device in the second preferred embodiment;

FIG. 15 explains the general outlines of processes performed by the image formation device and the management server in the second preferred embodiment;

FIGS. 16 and 17 are flow diagrams explaining an exemplary procedure of a process performed by the image formation device in the second preferred embodiment;

FIG. 18 is a block diagram showing an exemplary functional configuration realized by the control computer of the image formation device in a third preferred embodiment of the present invention;

FIG. 19 is a block diagram showing an exemplary functional configuration realized by the CPU of the management server in the third preferred embodiment;

FIG. 20 shows an example of a basic billing map of the third preferred embodiment;

FIG. 21 shows an example of a first replacement billing map of the third preferred embodiment;

FIG. 22 explains the general outlines of processes performed by the image formation device and the management server in the third preferred embodiment;

FIGS. 23 and 24 are flow diagrams explaining an exemplary procedure of a process performed by the image formation device in the third preferred embodiment;

FIG. 25 is a flow diagram explaining an exemplary procedure of a process performed by the management server in the third preferred embodiment; and

FIG. 26 explains an exemplary style of billing realized in a case where a plurality of image formation devices are connected in the third preferred embodiment of the present invention.

### DESCRIPTION OF THE PREFERRED EMBODIMENTS

Preferred embodiments of the present invention are described in detail below with reference to figures. In the description given below, those elements which are shared in common among the preferred embodiments are represented by the same reference numerals, and are not discussed repeatedly for the same description.

### First Preferred Embodiment

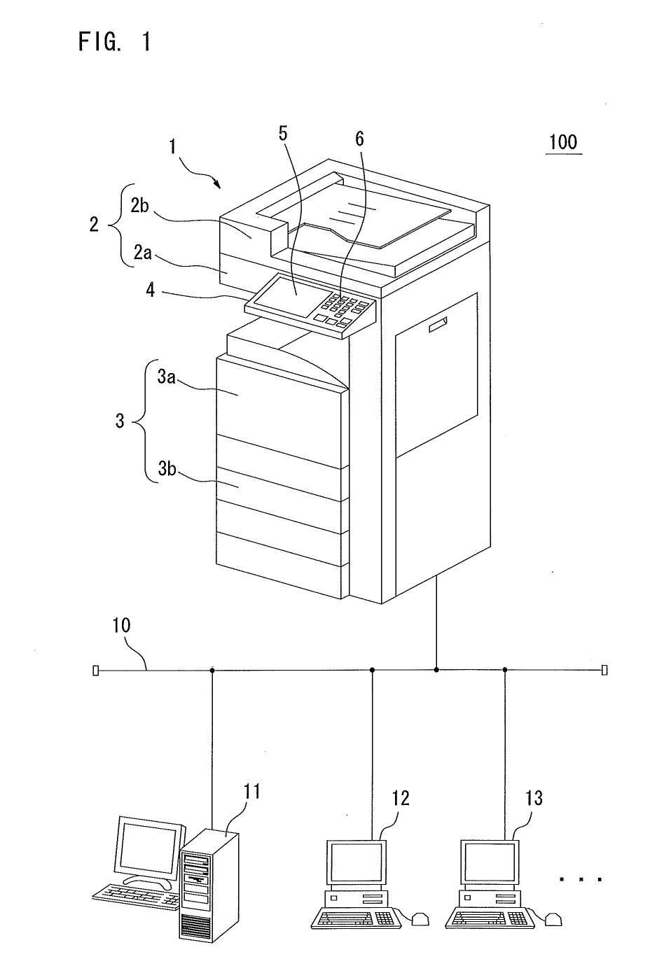

FIG. 1 shows an exemplary configuration of an image formation system 100 according to a first preferred embodiment of the present invention. The image formation system 100 includes an image formation device 1, a management server 11, and client computers 12, 13 and others that are connected through a network 10 such as a LAN, in a manner that allows data communication with each other.

In the first preferred embodiment, the image formation device 1 is a device generally called by a name such as a complex device or an MFP, and has several functions as a copier, a scanner, a printer, a facsimile and others. The image formation device 1 includes a scanner section 2 provided at the upper part of the device body, and a printer section 3 provided at the lower part of the device body. The image formation device 1 is provided with an operational panel 4 arranged on the front side of the scanner section 2, and through which a user makes an entry when using the image formation device 1.

The scanner section 2 includes an image reader 2a for optically reading the images of documents, and an automatic document feeder (ADF) 2b capable of holding a plurality of documents placed thereon, and from which the documents placed thereon are automatically fed one by one to the image reader 2a. The scanner section 2 causes the image reader 2a and the ADF 2b to operate in synchronization with each other, by which the image reader 2a can appropriately read documents being fed one by one by the ADF 2b. So, when a copy job, a scan job, a facsimile transmission job or others is executed, the scanner section 2 reads documents one by one to create image data.

The printer section 3 includes an image formation part 3a for forming an image by transferring a toner image to a printing medium such as an output sheet, and a sheet feed part 3b for supplying output sheets one by one to the image formation part 3a. The printer section 3 causes the sheet feed part 3b and the image formation part 3a to operate in synchronization with each other, by which a printed sheet is produced when a copy job, a print job or another job is executed. Although not shown in FIG. 1, a finishing processor such as an auto stapler for stapling sheets together is provided in a subsequent stage to the printer section 3.

The operational panel 4 includes a display part 5 for displaying various types of information to a user, and an operation part 6 through which the user makes entries to the image formation device 1. The display part 5 is formed for example from a liquid crystal display that can display color images. Screens to be displayed on the display part 5 include for example an operation guidance screen through which a user ID, a password and the like for user authentication is entered, and a login screen for receiving an operation for selecting a function, a setting operation, instructions for job execution and others after a user authenticated by the user authentication has logged in. The operation part 6 is formed from a plurality of operation keys including touch panel keys arranged on a surface of the display part 5, and a plurality of push-button keys arranged around the display part 5.

The management server 11 manages the image formation device 1 through the network 10. The management server 11 of the first preferred embodiment functions to authenticate a user who uses the image formation device 1, to hold and manage billing map information the image formation device 1 refers to when performing billing calculation in response to execution of a job, and to transmit the billing map information to the image formation device 1 when necessary.

The client computers 12, 13 and others are allocated, for example individually to each user. Each of the client computers 12, 13 and others can transmit print data to the image formation device 1 through the network 10. As an example, print data transmitted from each of the client computers 12, 13 and others contains user information for specifying a user. On receipt of the print data, the image formation device 1 authenticates a user based on the user information, and produces a printed sheet based on the received print data when the user who transmitted the print data has a right to produce a printed sheet.

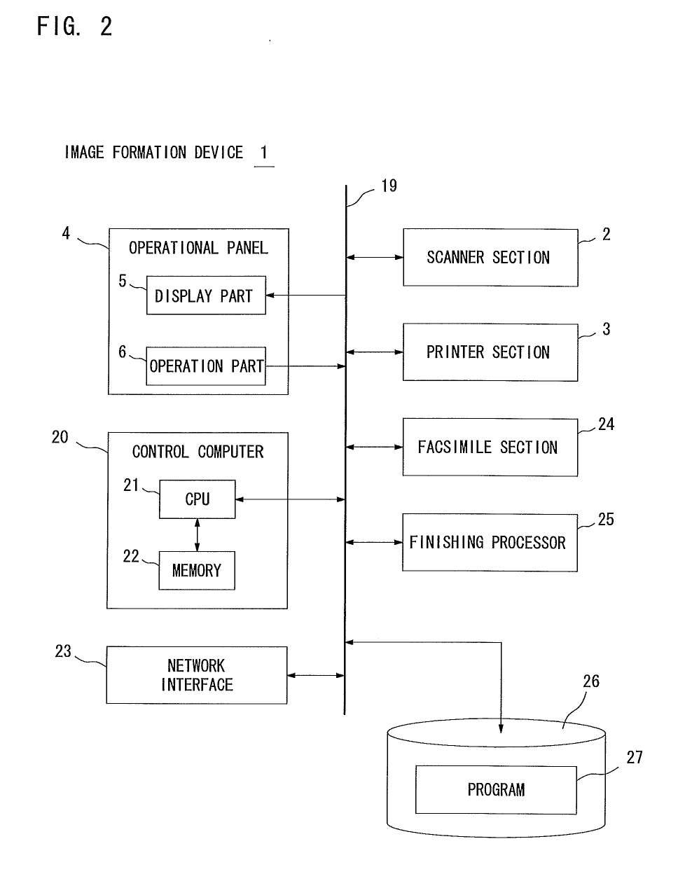

FIG. 2 is a block diagram showing an exemplary hardware configuration of the image formation device 1. In addition to the scanner section 2, the printer section 3 and the operational panel 4 described above, the image formation device 1 includes a control computer 20, a network interface 23, a facsimile section 24, a finishing processor 25, and a storage part 26. These components are connected to each other through a data bus 19 in a manner that allows data input and output to and from each component.

The control computer 20 includes a CPU 21 for reading and executing a program 27 stored in the storage part 26, and a memory 22 into which data of various types are temporarily stored when the CPU 21 performs a process based on the program 27. The control computer 20 processes data of various types, and controls the operation of other hardware sections. As an example, the control computer 20 creates a screen to be displayed on the display part 5 of the operational panel 4, and outputs the created screen to the display part 5. Further, when a user makes an operation through the operation part 6, the control computer 20 detects the operation, and performs a process based on the user's operation. The control computer 20 also functions as other processors, as described later.

The network interface 23 establishes connection to the network 10. By way of example, for user authentication in the image formation device 1, the control computer 20 establishes data communication with the management server 11 through the network interface 23. Further, the control computer 20 receives a billing map transmitted from the management server 11 through the network interface 23.

The facsimile section 24 sends and receives facsimile data. A communication network such as a telephone line not shown is connected to the facsimile section 24. As an example, when trying to send facsimile data, the control computer 20 outputs the facsimile data to the facsimile section 24. Then, the facsimile section 24 makes connection to the communication network, and transmits the facsimile data to a designated addressee.

The finishing processor 25 performs a predetermined finishing process on an output sheet fed from the printer section 3. The finishing process includes punching of a hole in an output sheet at a certain position, stapling for holding several output sheets together, or others. The finishing processor 25 of the first preferred embodiment can function at least to staple sheets. More particularly, the finishing processor 25 includes an auto stapler not shown, and can staple output sheets of a designated number together at a certain position.

The storage part 26 is a nonvolatile storage device such as a hard disk drive. The storage part 26 stores therein the program 27 described above. The storage part 26 also stores therein other types of data that are not described in the first preferred embodiment.

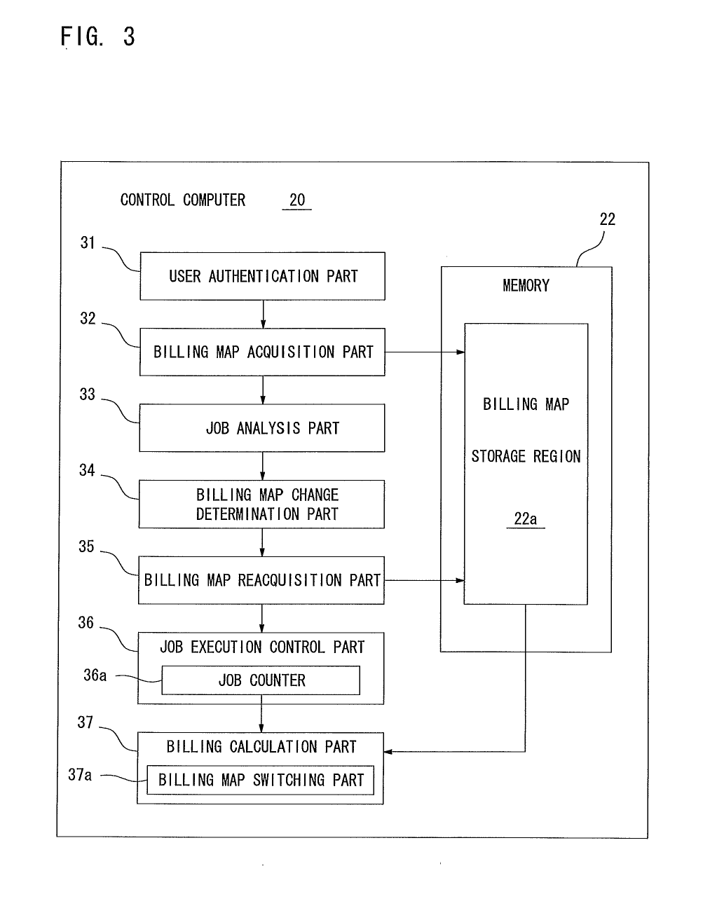

FIG. 3 is a block diagram showing an exemplary functional configuration realized by execution of the program 27 by the control computer 20. As shown in FIG. 3, the control computer 20 functions as a user authentication part 31, a billing map acquisition part 32, a job analysis part 33, a determination part 34 for making a determination as to billing map change, a billing map reacquisition part 35, a job execution control part 36, and a billing calculation part 37. The memory 22 of the control computer 20 has a billing map storage region 22a for storing therein a billing map acquired from the management server 11. The billing map storage region 22a is not necessarily provided in the memory 22, but may be provided in the storage part 26.

The user authentication part 31 authenticates a user who uses the image formation device 1. The user authentication part 31 comes into operation when detecting an entry of a user ID, a password and the like through the operational panel 4, or when receiving print data through the network 10. The user authentication part 31 performs user authentication based on the input information such as a user ID and a password. In the first preferred embodiment, the user authentication part 31 transmits a request for authentication to which the input information has been added, and determines whether or not the user has successfully been authenticated based on a result of the authentication given from the management server 11 in response to the request. When the user has successfully been authenticated, the user authentication part 31 switches the image formation device 1 to a state where the user has logged in to the image formation device 1. Thus, the authenticated user becomes a login user of the image formation device 1, so that the user can use various functions of the image formation device 1 based on a right of use of the functions set in advance for the user.

The billing map acquisition part 32 acquires a billing map corresponding to a login user. The billing map acquisition part 32 comes into operation when a user has successfully been authenticated by the user authentication part 31. The billing map acquisition part 32 acquires a billing map corresponding to the login user from the management server 11, and stores the acquired billing map into the billing map storage region 22a of the memory 22. As described in detail later, the billing map acquired at this time by the billing map acquisition part 32 is a basic billing map referred to for billing calculation at an initial stage of execution of a job when the login user provides instructions to execute the job.

The job analysis part 33 comes into operation when a login user provides instructions to execute a job, and analyzes the substance of the job. When the job is a print job, for example, the job analysis part 33 determines the total number of printed sheets to be produced, the total number of staples to be put in sheets and the like as a result of execution of the job based on print data. When the job is a copy job, like in the case of the print job, the job analysis part 33 determines the number of printed sheets to be produced, the total number of staples to be put in sheets and the like as a result of execution of the job based on user's setting. In the case of the copy job, however, the total number of printed sheets to be produced and the total number of staples to be put in sheets cannot be determined precisely before all documents have been read. So, in the case of the copy job, the job analysis part 33 comes into operation after document reading is completed, and then precisely determines the total number of printed sheets or the total number of staples. A result of the analysis made by the job analysis part 33 is given to the billing map change determination part 34.

The billing map change determination part 34 determines whether or not a billing map should be changed during execution of a job based on a result of analysis made by the job analysis part 33. More particularly, when a job designated by a user satisfies a predetermined condition, the billing map change determination part 34 determines that a billing map should be changed during execution of the job. In contrast, when the job does not satisfy the predetermined condition, the billing map change determination part 34 determines that the billing map is not required to be changed during execution of the job. In the first preferred embodiment, information about a predetermined condition (condition information), based on which the billing map change determination part 34 makes a determination, is contained in a billing map acquired from the management server 11. So, the billing map change determination part 34 reads the condition information from the billing map stored in the billing map storage region 22a, and makes the above-described determination based on the read condition information and a result of the analysis made by the job analysis part 33. A result of the determination made by the billing map change determination part 34 is given to the billing map reacquisition part 35.

When it is determined, based on a result of the determination made by the billing map change determination part 34, that a billing map should be changed during execution of a job designated by a user, the billing map reacquisition part 35 requests the management server 11 to reacquire a billing map. Then, the billing map reacquisition part 35 acquires a replacement billing map different from a billing map acquired in advance from the management server 11, and which is to take the place of the previously acquired billing map during execution of a job. The replacement billing map acquired at this time is also stored in the billing map storage region 22a of the memory 22. The replacement billing map is acquired for example before execution of a job designated by a user. In the case of a copy job, however, the replacement billing map is acquired before the printer section 3 starts to produce a printed sheet. The replacement billing map acquired by the billing map reacquisition part 35 is described in detail later.

The job execution control part 36 actuates each of the scanner section 2, the printer section 3, the network interface 23, the facsimile section 24, and the finishing processor 25 when necessary, thereby controlling the execution of a job designated by a user. The job execution control part 36 includes a job counter 36a. Each time a process that is a target of billing is performed during execution of a job designated by a user, the counter 36a counts up a count value by one that corresponds to the process. As an example, in the case of a copy job, the job counter 36a counts up a count value by one that indicates the number of printed sheets produced each time the printer section 3 produces a printed sheet. As another example, when stapling is designated as a finishing process, the job counter 36a counts up a count value by one that indicates the number of staples each time the finishing processor 25 puts a staple into sheets. The count of the job counter 36a is given to the billing calculation part 37.

The billing calculation part 37 reads a billing map stored in the billing map storage region 22a, and performs billing calculation in response to execution of a job by the job execution control part 36. For billing calculation, the billing calculation part 37 refers to a billing map read from the billing map storage region 22a, and performs calculation based on unit price information of each process as a target of billing contained in the read billing map. The billing calculation part 37 has a billing map switching part 37a.

The billing map switching part 37a switches a billing map to be referred to by the billing calculation part 37 to a replacement billing map at a time when the progress of a job satisfies a predetermined condition. The billing map switching part 37a checks on a condition under which a billing map is changed based on condition information contained in a billing map that is being referred to by the billing calculation part 37. Then, while monitoring the progress of a job in real time based on an output from the job counter 36a, the billing map switching part 37a switches a billing map to be referred to by the billing calculation part 37 to a replacement billing map stored in the billing map storage region 22a when the progress of the job satisfies a predetermined condition.

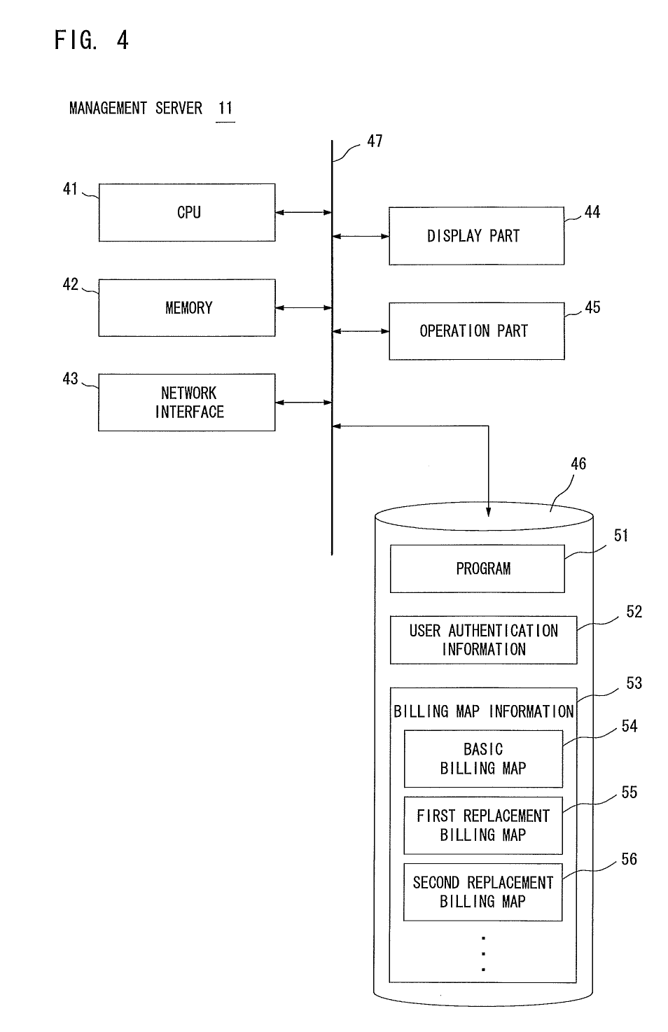

FIG. 4 is a block diagram showing an exemplary hardware configuration of the management server 11. The management server 11 includes a CPU 41, a memory 42, a network interface 43, a display part 44, an operation part 45, and a storage part 46. These components are connected to each other through a data bus 47 in a manner that allows data input and output to and from each component.

The CPU 41 reads and executes a program 51 stored in the storage part 46, by which the CPU 41 becomes operative to function as processors described later. The memory 42 stores therein temporary data used by the CPU 41 to perform various processes. The network interface 43 establishes connection to the network 10. Data communication with the image formation device 1 is realized through the network interface 43. The display part 44 is formed for example from a liquid crystal display. The operation part 45 is formed from a keyboard, a mouse or the like. The storage part 46 is formed from a nonvolatile storage device such as a hard disk drive. The storage part 46 stores therein user authentication information 52, billing map information 53 and others as well as the above-described program 51. The billing map information 53 stored in the storage part 46 contains a plurality of billing maps. In the example of FIG. 4, the billing map information 53 contains a basic billing map 54, a first replacement billing map 55, a second replacement billing map 56 and others.

As already described, the basic billing map 54 is billing information to be referred to for billing calculation at an initial stage of execution of a job. The first replacement billing map 55 is billing information which takes the place of the basic billing map 54 when the progress of the job satisfies a predetermined condition, and which is to be referred to for billing calculation at a subsequent stage. The second replacement billing map 56 is billing information which takes the place of the first replacement billing map 55 when the progress of the job satisfies another condition, and which is to be referred to for billing calculation at a further subsequent stage.

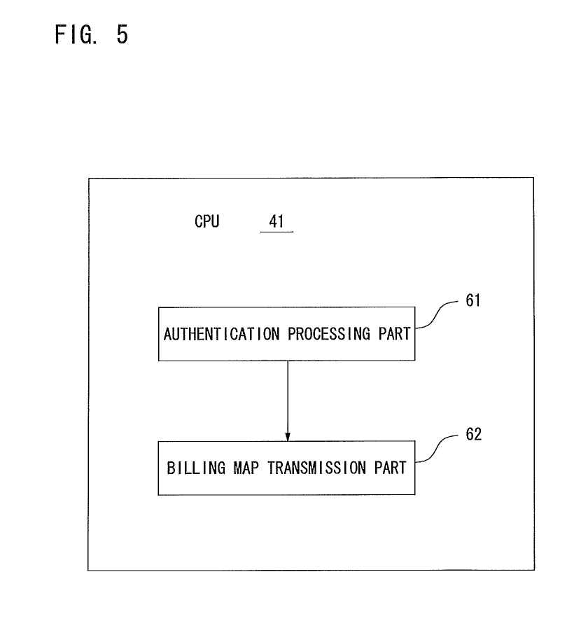

FIG. 5 is a block diagram showing an exemplary functional configuration realized by execution of the program 51 by the CPU 41. As shown in FIG. 5, the CPU 41 becomes operative to function as an authentication processing part 61 and a billing map transmission part 62.

The authentication processing part 61 authenticates a user who uses the image formation device 1, and comes into operation when receiving a request for authentication from the image formation device 1. On receipt of the request for authentication from the image formation device 1, the authentication processing part 61 reads the user authentication information 52 from the storage part 46, and then performs authentication. The user authentication information 52 contains information about a user authorized to use the image formation device 1. The user authentication information 52 contains information such as a user ID, a password and the like of each registered user, and information about a right of use of a function set for each registered user when the user uses the image formation device 1. The authentication processing part 61 searches the user authentication information 52 based on information added to the request for authentication, and determines whether or not a user to be authenticated is a user registered in advance with the user authentication information 52. When the user is a registered user in the user authentication information 52, the authentication processing part 61 transmits a result of the authentication to the image formation device 1 notifying that the user has successfully been authenticated. The user authentication processing part 61 also transmits information about a right of use of at least one function set for the registered user thereby authenticated to the image formation device 1. When the user is not a registered user, the authentication processing part 61 transmits a result of the authentication to the image formation device 1 notifying that the authentication ends in failure.

The billing map transmission part 62 reads one of the plurality billing maps 54, 55, 56 and others to be transmitted to the image formation device 1 from the billing map information 53 stored in the storage part 46, and transmits the read billing map to the image formation device 1. The billing map transmission part 62 comes into operation when the authentication processing part 61 successfully authenticates a user. In this case, the billing map transmission part 62 reads the basic billing map 54 from the billing map information 53, and transmits the same to the image formation device 1. The billing map transmission part 62 also comes into operation when a request to reacquire a billing map is received from the image formation device 1. In this case, the billing map transmission part 62 reads the first or second replacement billing map 55 or 56 from the billing map information 53, and transmits the same to the image formation device 1.

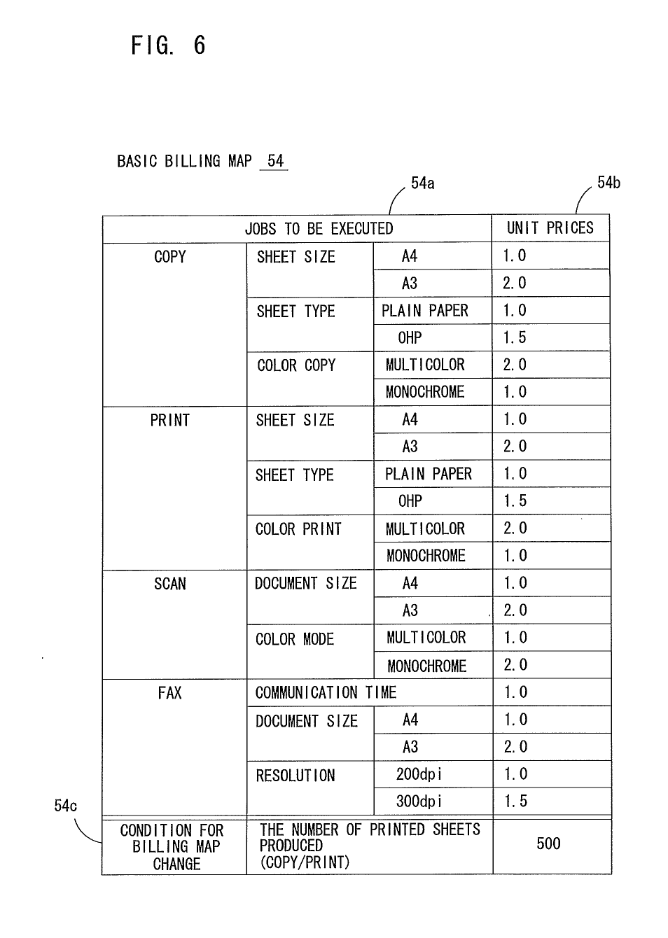

Billing maps contained in the billing map information 53 are described next. FIG. 6 shows an example of the basic billing map 54. As already described, the basic billing map 54 is transmitted to the image formation device 1 immediately after a user is successfully authenticated. The basic billing map 54 is billing information to be referred to for billing calculation at an initial stage of execution of a job in the image formation device 1. As shown in FIG. 6, the basic billing map 54 contains information 54a about targets of billing of jobs to be executed in the image formation device 1, and unit price information 54b about the targets. So, by referring to the basic billing map 54, billing calculation can be performed in response to execution of a job. The basic billing map 54 also contains condition information 54c under which a billing map to be referred to for billing calculation in response to execution of a job is changed to the first replacement billing map 55. In the example of FIG. 6, the condition information 54c indicates that the basic billing map 54 should be changed to the first replacement billing map 55 when the number of printed sheets produced in a copy job or a print job reaches 500.

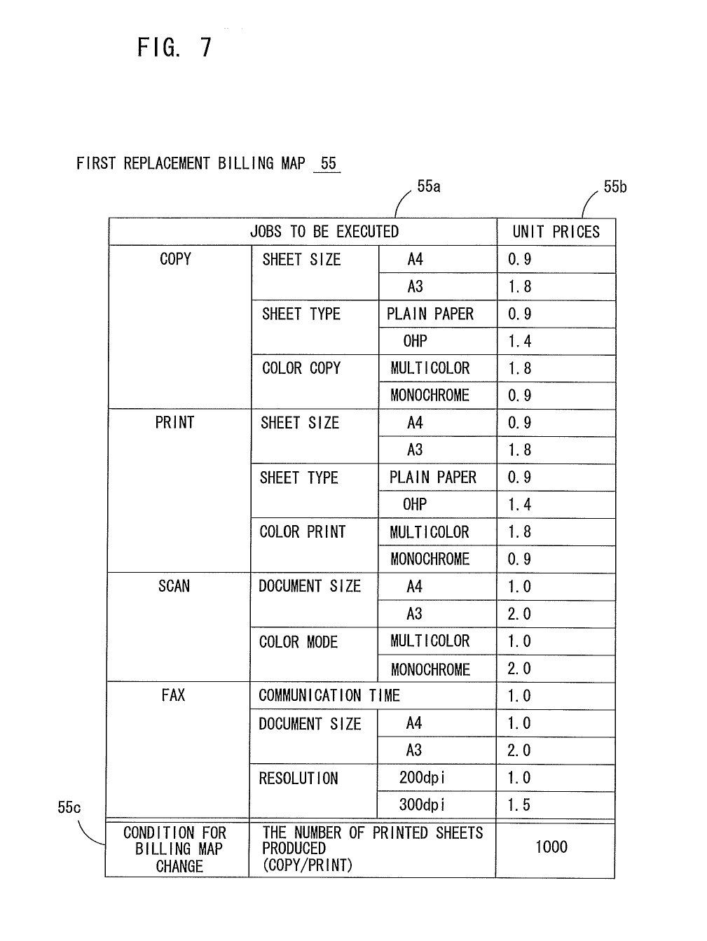

FIG. 7 shows an example of the first replacement billing map 55. The first replacement billing map 55 of FIG. 7 is billing information to be referred to for billing calculation at a subsequent stage when the number of printed sheets produced reaches 500 during billing calculation based on the basic billing map 54 of FIG. 6. As shown in FIG. 7, the first replacement billing map 55 contains information 55a about targets of billing of jobs to be executed in the image formation device 1, and unit price information 55b about the targets. As seen from the comparison of the unit price information 55b in FIG. 7 from the unit price information 54b in FIG. 6, the unit price information 55b about a copy job or a print job in the first replacement billing map 55 defines unit prices at about 10 percent below the corresponding prices defined by the unit price information 54b about a copy job or a print job in the basic billing map 54. So, in this example, when the number of printed sheets produced exceeds 500 during execution of a job, billing calculation in response to execution of the job at a subsequent stage is performed at a discount of about 10 percent. The first replacement billing map 55 contains condition information 55c under which a billing map to be referred to for billing calculation in response to execution of a job is changed to the second replacement billing map 56. In the example of FIG. 7, the condition information 55c indicates that the first replacement billing map 55 should be changed to the second replacement billing map 56 when the number of printed sheets produced in a copy job or a print job reaches 1000.

Although not shown, the second replacement billing map 56 is formed by the same way as the first replacement billing map 55. As an example, unit prices defined by unit price information about a copy job or a print job in the second replacement billing map 56 are set lower than the corresponding unit prices defined by the unit price information 55b in the first replacement billing map 55. In this case, billing calculation can be performed at a discount that gradually varies in response to execution of a job.

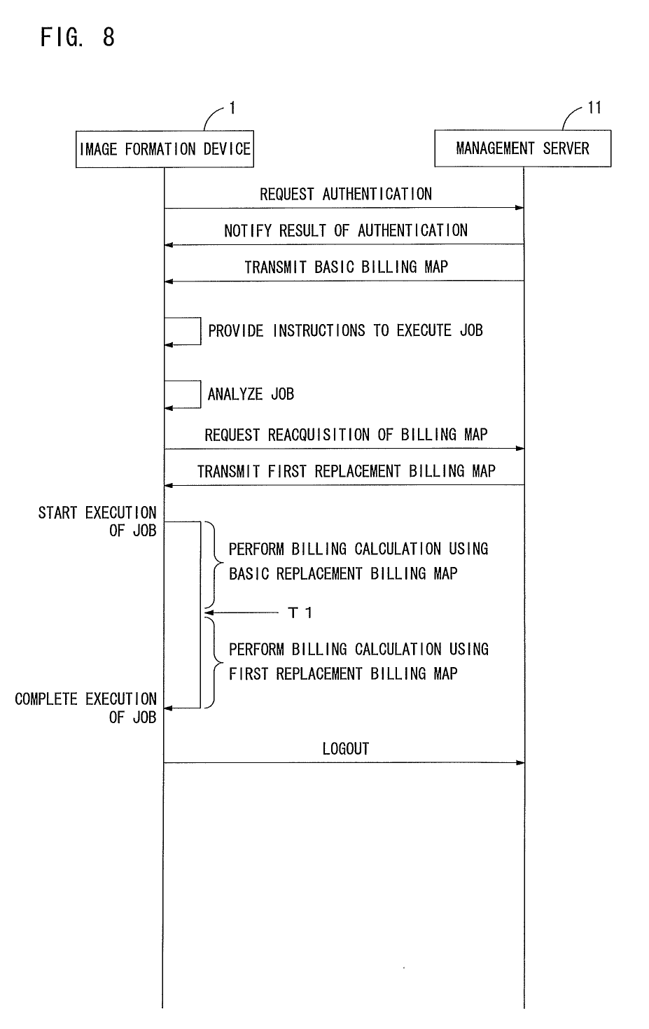

The general outlines of processes performed by the image formation device 1 and the management server 11 in the first preferred embodiment are described next with reference to FIG. 8. When a user operates the operational panel 4 to enter a user ID, a password and the like, for example, the image formation device 1 transmits a request for authentication to the management server 11. On receipt of the request for authentication, the management server 11 authenticates a user, and transmits a result of the authentication to the image formation device 1. When the result of the authentication is to notify that the user has successfully been authenticated, the management server 11 reads the basic billing map 54, and transmits the same to the image formation device 1.

On receipt of the result of the authentication notifying that the user has successfully been authenticated from the management server 11, the image formation device 1 is switched to a state where the user has logged in to the image formation device 1. Next, the image formation device 1 receives the basic billing map 54 from the management server 11. When the login user makes various setting operations and the like and provides instructions to execute a job thereafter, the image formation device 1 analyzes a job designated by the login user. When it is determined as a result of the analysis that a condition defined by the condition information 54c in the basic billing map 54 and under which a billing map is changed is satisfied, for example when the number of printed sheets to be produced exceeds 500, the image formation device 1 requests the management server 11 to reacquire a billing map. On receipt of the request for reacquisition, the management server 11 reads the first replacement billing map 55, and transmits the same to the image formation device 1.

After every billing map required for execution of the job is acquired as a result of acquisition of the first replacement billing map 55 from the management server 11, the image formation device 1 starts execution of the job. After starting execution of the job, the image formation device 1 performs billing calculation based on the basic billing map 54 in response to execution of the job. When the number of printed sheets produced reaches 500 at a time T1 indicated in FIG. 8 that is defined as a condition under which a billing map is changed, the image formation device 1 switches a billing map to be referred to for billing calculation from the basic billing map 54 to the first replacement billing map 55. The image formation device 1 thereafter performs billing calculation based on the first replacement billing map 55 in response to execution of the job. Billing calculation is completed as a result of completion of execution of the job. When the login user makes a logout operation thereafter, the image formation device 1 notifies the management server 11 of the logout of the login user.

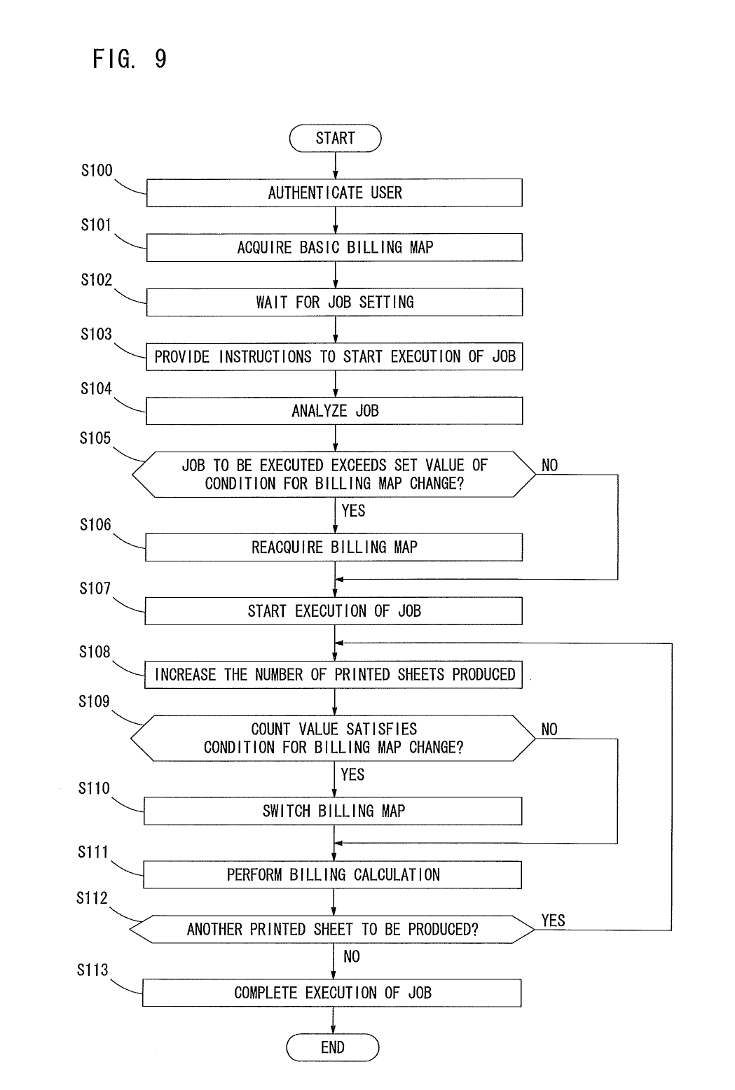

FIG. 9 is a flow diagram explaining an exemplary procedure of a process performed by the image formation device 1 in the first preferred embodiment. The image formation device 1 authenticates a user (step S100), and acquires the basic billing map 54 from the management server 11 (step S101) when the user has successfully been authenticated. Then, the image formation device 1 is placed in a state to wait for a user's setting operation of a job (step S102). When a user provides instructions to start execution of the job (step S103), the image formation device 1 analyzes the substance of the job (step S104). Then, the image formation device 1 determines whether or not a set value of the job to be executed exceeds a set value of a condition defined by the condition information 54c in the basic billing map 54 and under which a billing map is changed (step S105). When the set value of the job to be executed does not exceed the set value of the condition, the image formation device 1 does not reacquire a billing map. In contrast, when the set value of the job to be executed exceeds the set value of the condition defined by the condition information 54c in the basic billing map 54 and under which a billing map is changed, the image formation device 1 requests the management server 11 to reacquire a billing map, and then reacquires a billing map (step S106). The billing map acquired here is the first replacement billing map 55. After acquiring the first replacement billing map 55, the image formation device 1 may determine whether or not the set value of the job to be executed exceeds a set value of a condition defined by the condition information 55c in the first replacement billing map 55 and under which a billing map is changed. When the set value of the job to be executed exceeds the set value of the condition, the image formation device 1 may further acquire the second replacement billing map 56.

Next, the image formation device 1 starts execution of the job (step S107), by which printed sheets are produced one by one by the printer section 3, for example. Then, the image formation device 1 counts up the number of printed sheets produced (step S108), and determines whether or not its count value satisfies the condition defined by the condition information 54c in the basic billing map 54 and under which a billing map is changed (step S109). When the count value does not satisfy the condition (when a result of step S109 is NO), the image formation device 1 performs billing calculation based on the basic billing map 54 (step S111). In contrast, when the count value satisfies the condition (when a result of step S109 is YES), the image formation device 1 switches a billing map to be referred to for billing calculation from the basic billing map 54 to the first replacement billing map 55 (step S110). Then, the image formation device 1 performs billing calculation based on the first replacement billing map 55 (step S111). Next, the image formation device 1 determines whether or not there is another printed sheet to be produced (step S112). When there is another printed sheet to be produced (when a result of step S112 is YES), the image formation device 1 returns to step S108 to repeat the process described above. In contrast, when there is no printed sheet to be produced, the image formation device 1 completes execution of the job (step S113), thereby completing the process.

By following the process described above, when the progress of a job satisfies a predetermined condition, for example when the number of printed sheets produced reaches or exceeds a certain number during execution of the job, the image formation device 1 can change a billing map to be referred to for billing calculation at that time. So, when a user uses the image formation device 1 to produce a large number of printed sheets, for example, billing for a printed sheet, produced after a certain number of printed sheets were produced, is made at a discount. This realizes various styles of billing.

### Second Preferred Embodiment

A second preferred embodiment of the present invention is described next. In the second preferred embodiment, for change of a billing map in the image formation device 1, only part of a basic billing map 54 is rewritten. The configurations of the image formation system 100, the image formation device 1 and the management server 11 of the second preferred embodiment are the same as those of the first preferred embodiment, except for features described below.

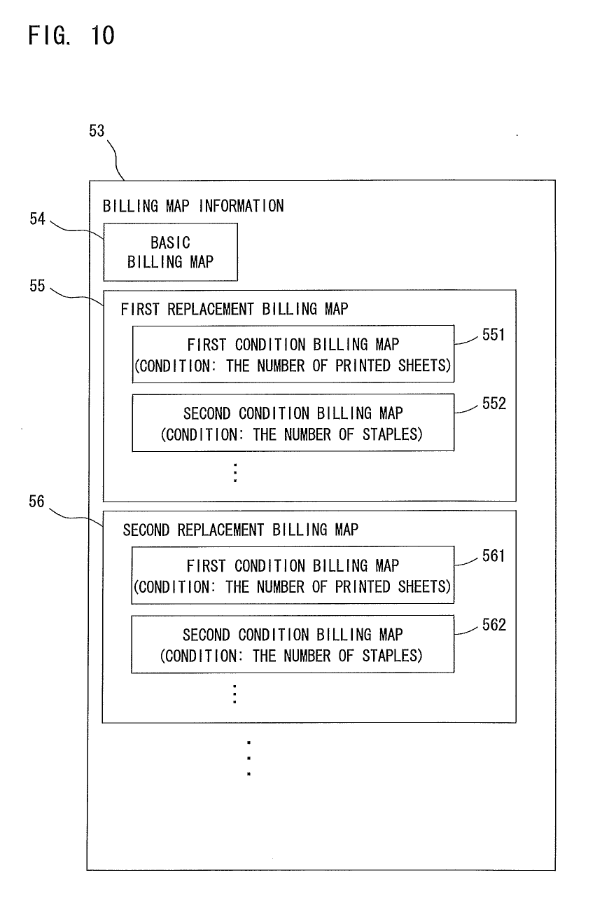

FIG. 10 shows an example of billing map information 53 stored in the storage part 46 of the management server 11 in the second preferred embodiment. Like that of the first preferred embodiment, the billing map information 53 of the second preferred embodiment contains a basic billing map 54, a first replacement billing map 55, a second replacement billing map 56 and others. Unlike those of first preferred embodiment, the first and second replacement billing maps 55 and 56 of the second preferred embodiment each include a plurality of billing maps.

The first replacement billing map 55 includes a first condition billing map 551, a second condition billing map 552 and others. Each of the first and second condition billing maps 551, 552 and others is information with which part of unit price information in the basic billing map 54 is rewritten. By way of example, the first condition billing map 551 is information with which billing information about printing in the basic billing map 54 is rewritten when the number of printed sheets produced during execution of a job satisfies a predetermined condition. The second condition billing map 552 is information with which billing information about stapling in the basic billing map 54 is rewritten when the number of staples put in sheets satisfies a predetermined condition. Namely, the first and second condition billing maps 551 and 552 are responsive to different conditions under which billing maps are changed. Parts of billing information corresponding to the conditions are rewritten with the first and second condition billing maps 551 and 552.

The second replacement billing map 56 includes a first condition billing map 561, a second condition billing map 562 and others. The first and second condition billing maps 561, 562 and others correspond to the first and second condition billing maps 551, 552 and others of the first replacement billing map 55. The first condition billing map 561 is information with which billing information is rewritten when the number of printed sheets produced satisfies another predetermined condition with part of the unit price information in the basic billing map 54 rewritten with the first condition billing map 551 of the first replacement billing map 55. The second condition billing map 562 is information with which billing information is rewritten when the number of staples put in sheets satisfies another predetermined condition with part of the unit price information in the basic billing map 54 rewritten with the second condition billing map 552 of the first replacement billing map 55.

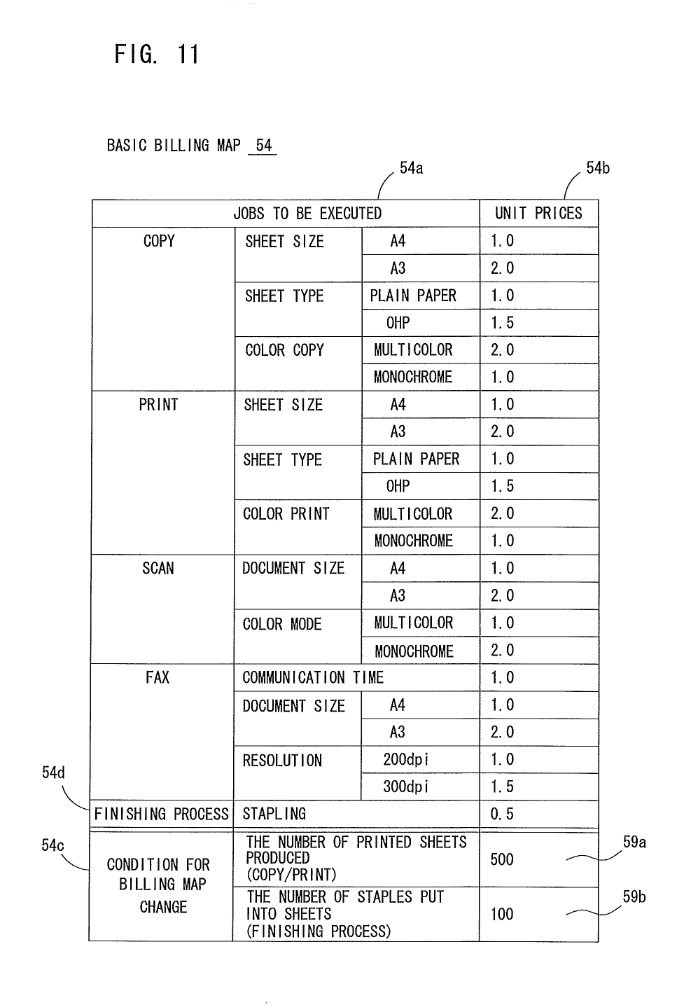

FIG. 11 shows an example of the basic billing map 54 of the second preferred embodiment. The basic billing map 54 is transmitted from the management server 11 to the image formation device 1 immediately after a user is successfully authenticated. The basic billing map 54 is billing information to be referred to for billing calculation at an initial stage of execution of a job in the image formation device 1. As shown in FIG. 11, the basic billing map 54 contains information 54a about targets of billing of jobs to be executed in the image formation device 1, and unit price information 54b about the targets. In the second preferred embodiment, the basic billing map 54 contains billing information 54d to be referred to when staples are put in sheets in a finishing process. Condition information 54c contains a plurality of conditions (a first condition 59a and a second condition 59b) under each of which a billing map is changed. As an example, the first condition 59a is a condition under which the unit price information 54b about a copy job and a print job in the basic billing map 54 is changed to the first condition billing map 551 of the first replacement billing map 55. In the example of FIG. 11, this condition indicates that the unit price information 54b about a copy job and a print job should be changed when the number of printed sheets produced reaches 500. The second condition 59b is a condition under which the unit price information 54b about stapling in the basic billing map 54 is changed to the second condition billing map 552 of the first replacement billing map 55. In the example of FIG. 11, this condition indicates that the unit price information 54b about stapling should be changed when the number of staples put in sheets reaches 100.

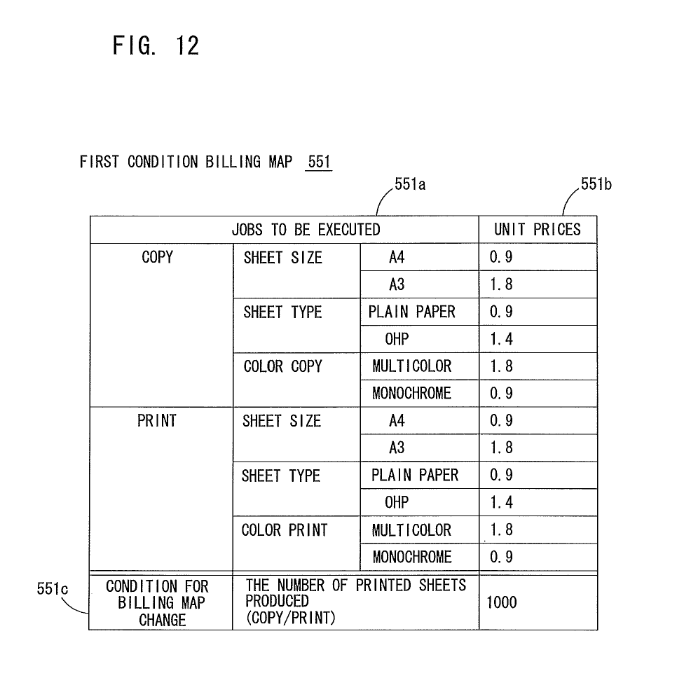

FIG. 12 shows an example of the first condition billing map 551 of the first replacement billing map 55. The first condition billing map 551 of FIG. 12 is billing information to be referred to for calculation of billing for printed sheets to be produced at a subsequent stage when the number of printed sheets produced reaches 500 during billing calculation based on the basic billing map 54 of FIG. 11. As shown in FIG. 12, the first condition billing map 551 contains information 551a about targets of billing of a copy job and a print job, and unit price information 551b about the targets. As seen from the comparison of the unit price information 551b in FIG. 12 from the unit price information 54b in FIG. 11, the unit price information 551b in the first condition billing map 551 defines unit prices at about 10 percent below the corresponding prices defined by the unit price information 54b about a copy job or a print job in the basic billing map 54. So, in this example, when the number of printed sheets produced exceeds 500 during execution of a job, billing calculation in response to execution of the job at a subsequent stage is performed at a discount of about 10 percent. The first condition billing map 551 of the first replacement billing map 55 contains condition information 551c under which a billing map to be referred to for billing calculation in response to execution of a job is changed to the first condition billing map 561 of the second replacement billing map 56. In the example of FIG. 12, the condition information 551c indicates that the first condition billing map 551 should be changed to the first condition billing map 561 when the number of printed sheets produced reaches 1000.

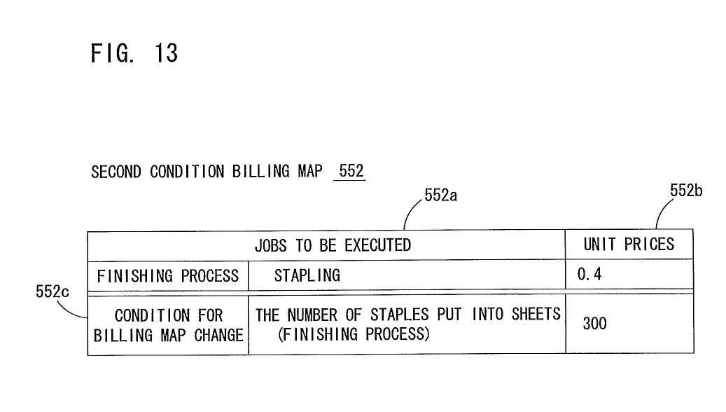

FIG. 13 shows an example of the second condition billing map 552 of the first replacement billing map 55. The second condition billing map 552 of FIG. 13 is billing information to be referred to for calculation of billing for staples to be put in sheets at a subsequent stage when the number of staples put in sheets reaches 100 during billing calculation based on the basic billing map 54 of FIG. 11. As shown in FIG. 13, the second condition billing map 552 contains information 552a about stapling and its corresponding unit price information 552b. As seen from the comparison of the unit price information 552b in FIG. 13 from the unit price information 54b in FIG. 11, the unit price information 552b in the second condition billing map 552 defines a unit price at about 10 percent below the corresponding price defined by the unit price information 54b about stapling in the basic billing map 54. So, in this example, when the number of staples put in sheets exceeds 100 during execution of a job, billing calculation in response to execution of the job at a subsequent stage is performed at a discount of about 10 percent. The second condition billing map 552 of the first replacement billing map 55 contains condition information 552c under which a billing map to be referred to for billing calculation in response to execution of a job is changed to the second condition billing map 562 of the second replacement billing map 56. In the example of FIG. 13, the condition information 552c indicates that the second condition billing map 552 should be changed to the second condition billing map 562 when the number of staples put in sheets reaches 300.

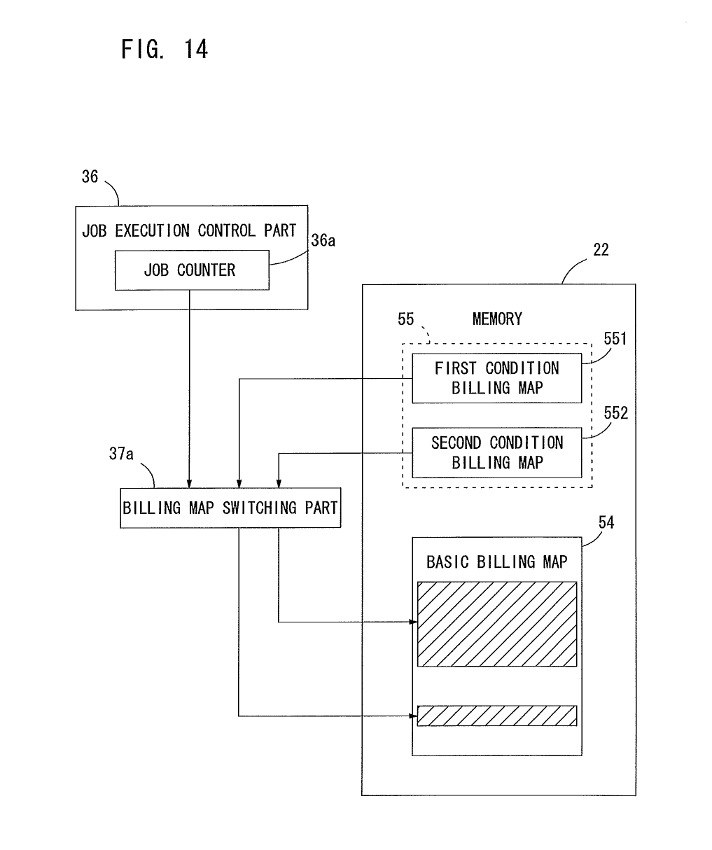

FIG. 14 explains an idea on how to rewrite the basic billing map 54 in order to change a billing map to be referred to for billing calculation in the image formation device 1 of the second preferred embodiment. The example of FIG. 14 is given on the assumption that the image formation device 1 acquires the basic billing map 54, and the first and second condition billing maps 551 and 552 of the first replacement billing map 55 in advance from the management server 11, and stores the acquired maps in the memory 22. In the job execution control part 36, after execution of a job is started, the job counter 36a counts the number of printed sheets produced and the number of staples put in sheets as a result of execution of the corresponding jobs. The count values thereby obtained are given to the billing map switching part 37a. The billing map switching part 37a monitors the progresses of the jobs based on the condition information 54c in the basic billing map 54. When the first condition 59a is satisfied, the billing map switching part 37a rewrites part of the basic billing map 54 developed in the memory 22 with the first condition billing map 551. When the second condition 59b is satisfied, the billing map switching part 37a rewrites part of the basic billing map 54 developed in the memory 22 with the second condition billing map 552. Compared to the full rewrite of the basic billing map 54, such partial rewrite of the basic billing map 54 is efficiently done. So, a processing burden placed on the image formation device 1 is reduced when a billing map to be referred to for billing calculation is changed. Further, billing calculation using a new billing map is performed efficiently in the image formation device 1.

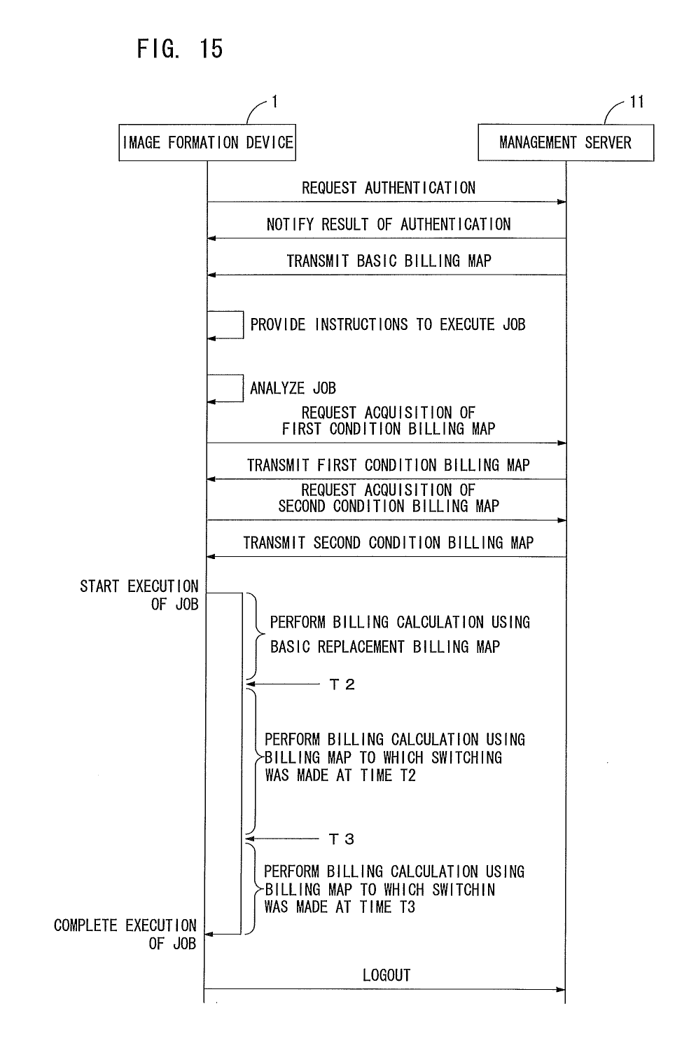

The general outlines of processes performed by the image formation device 1 and the management server 11 in the second preferred embodiment are described next with reference to FIG. 15. First, the image formation device 1 transmits a request for authentication to the management server 11. On receipt of the request for authentication, the management server 11 authenticates a user, and transmits a result of the authentication to the image formation device 1. When the result of the authentication is to notify that the user has successfully been authenticated, the management server 11 reads the basic billing map 54 from the billing map information 53, and transmits the same to the image formation device 1.

On receipt of the result of the authentication notifying that the user has successfully been authenticated from the management server 11, the image formation device 1 is switched to a state where the user has logged in to the image formation device 1. Next, the image formation device 1 receives the basic billing map 54 from the management server 11. When the login user makes various setting operations and the like and provides instructions to execute a job thereafter, the image formation device 1 analyzes a job designated by the login user. This analysis is intended to determine whether or not the job designated by the user satisfies the first or second condition information 59a or 59b contained in the condition information 54c in the basic billing map 54. The first condition 59a is satisfied when the number of printed sheets produced by execution of the job exceeds 500. In this case, the image formation device 1 requests the management server 11 to acquire the first condition billing map 551 of the first replacement billing map 55. On receipt of the request for acquisition, the management server 11 reads the first condition billing map 551, and transmits the same to the image formation device 1. The second condition 59b is satisfied when the number of staples put in sheets by execution of the job exceeds 100. In this case, the image formation device 1 requests the management server 11 to acquire the second condition billing map 552 of the first replacement billing map 55. On receipt of the request for acquisition, the management server 11 reads the second condition billing map 552, and transmits the same to the image formation device 1.

After every billing map required for execution of the job is acquired as a result of acquisition of the first and second condition billing maps 551 and 552 from the management server 11, the image formation device 1 starts execution of the job. After starting execution of the job, the image formation device 1 performs billing calculation based on the basic billing map 54 in response to execution of the job. When a set value of one of the first and second conditions 59a and 59b is reached at a time T2 indicated in FIG. 15, the image formation device 1 switches part of the basic billing map 54 to be referred to for billing calculation to the first or second condition billing map 551 or 552. The image formation device 1 thereafter performs billing calculation based on the basic billing map 54 to which switching was made at the time T2. Next, when a set value of the other one of the first and second conditions 59a and 59b is reached at a time T3 indicated in FIG. 15, the image formation device 1 switches different part of the basic billing map 54 to be referred to for billing calculation to the second or first condition billing map 552 or 551. The image formation device 1 thereafter performs billing calculation based on the basic billing map 54 to which switching was made at the time T3. Billing calculation is completed as a result of completion of execution of the job. When the login user makes a logout operation thereafter, the image formation device 1 notifies the management server 11 of the logout of the login user.

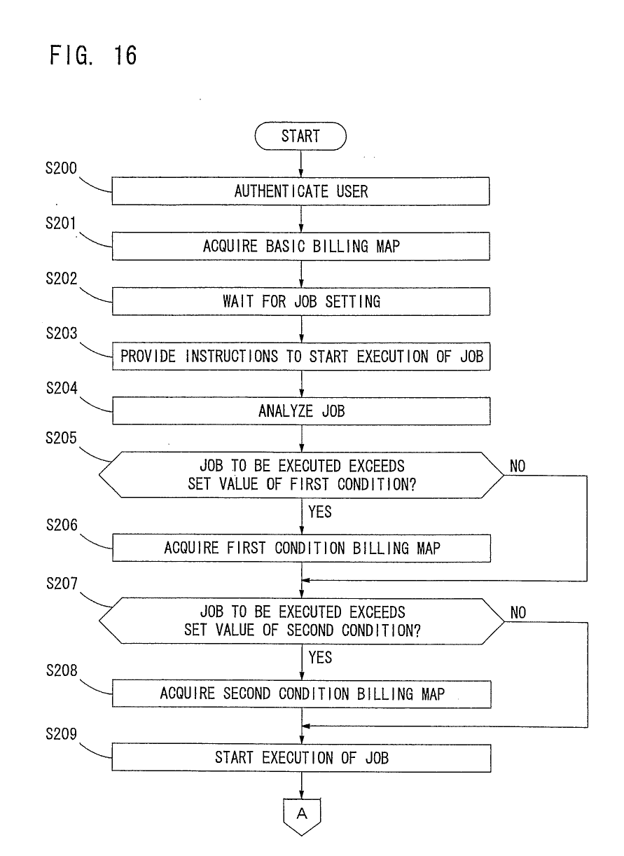

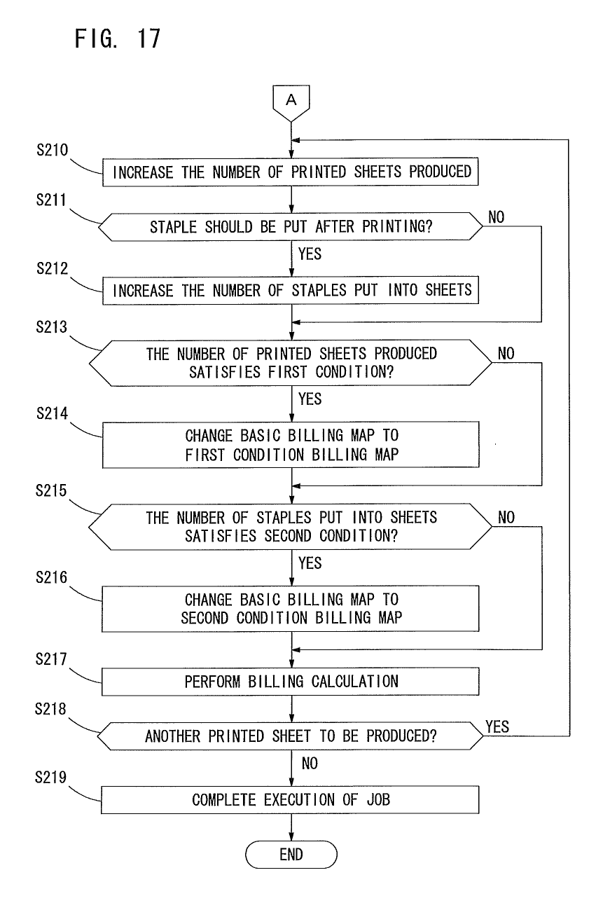

FIGS. 16 and 17 are flow diagrams explaining an exemplary procedure of a process performed by the image formation device 1 in the second preferred embodiment. Steps S200 to 5204 in the flow diagram of FIG. 16 are the same as steps S100 to S104 in the flow diagram of FIG. 9, and so are not described in the second preferred embodiment.

After analyzing a job (step S204) for which a user gave instructions for execution, the image formation device 1 determines whether or not a set value of the job to be executed exceeds a set value of the first condition 59a defined by the condition information 54c in the basic billing map 54 (step S205). When the set value of the job to be executed does not exceed the set value of the first condition 59a, the image formation device 1 does not acquire the first condition billing map 551. In contrast, when the set value of the job to be executed exceeds the set value of the first condition 59a, the image formation device 1 requests the management server 11 to acquire the first condition billing map 551, and then acquires the first condition billing map 551 (step S206).

Next, the image formation device 1 determines whether or not the set value of the job to be executed exceeds a set value of the second condition 59b defined by the condition information 54c in the basic billing map 54 (step S207). When the set value of the job to be executed does not exceed the set value of the second condition 59b, the image formation device 1 does not acquire the second condition billing map 552. In contrast, when the set value of the job to be executed exceeds the set value of the second condition 59b, the image formation device 1 requests the management server 11 to acquire the second condition billing map 552, and then acquires the second condition billing map 552 (step S208).

Although not shown in FIG. 16, the image formation device 1 may determine, after acquisition of the first or second condition billing map 551 or 552, whether or not the set value of the job to be executed exceeds the set value of the condition defined by the condition information 551c or 552c in the first or second condition billing map 551 or 552. When the set value of the job to be executed exceeds the set value of either condition, the image formation device 1 may further acquire the billing map 561 or 562 of the second replacement billing map 56.

Next, the image formation device 1 starts execution of the job (step S209). Then, the printer section 3 starts to produce printed sheets one by one, staples are put in the printed sheets of a fixed number, and the printed sheets produced are output, for example. Referring next to the flow diagram of FIG. 17, after starting execution of the job, the image formation device 1 counts up a count value by one that corresponds to the number of printed sheets produced (step S210). Next, the image formation device 1 determines whether or not a staple should be put after the most recent printed sheet is produced (step S211). Here, the image formation device 1 checks to see whether or not the number of printed sheets produced into which a staple is to be put becomes the same as the fixed number designated by the user as a result of addition of the most recent printed sheet. When the number of printed sheets produced into which a staple is to be put is the same as the fixed number, the image formation device 1 determines that a staple should be put in these printed sheets. When determining that a staple should be put in the printed sheets, the image formation device 1 counts up a count value by one that corresponds to the number of staples put in sheets (step S212). In contrast, when a staple should not be put in sheets, the image formation device 1 does not count up the number of staples.

The image formation device 1 thereafter determines whether or not the count value of the number of printed sheets produced satisfies the first condition 59a defined by the condition information 54c in the basic billing map 54 (step S213). When the count value satisfies the first condition 59a (when a result of step S213 is YES), part of the basic billing map 54 being referred to for billing calculation is switched to the first condition billing map 551 (step S214). In contrast, when the count value of the number of printed sheets produced does not satisfy the first condition 59a (when a result of step S213 is NO), the image formation device 1 does not make switching of the basic billing map 54.

Next, the image formation device 1 determines whether or not the count value of the number of staples put in sheets satisfies the second condition 59b defined by the condition information 54c in the basic billing map 54 (step S215). When the count value satisfies the second condition 59b (when a result of step S215 is YES), part of the basic billing map 54 being referred to for billing calculation is switched to the second condition billing map 552 (step S216). In contrast, when the count value of the number of staples put in sheets does not satisfy the second condition 59b (when a result of step S215 is NO), the image formation device 1 does not make switching of the basic billing map 54.

Then, the image formation device 1 performs billing calculation in response to production of one printed sheet (step S217). As an example, when a billing map is changed in step S214 or 5216 described above, this calculation is performed on the basis of the new billing map.

Next, the image formation device 1 determines whether or not there is another printed sheet to be produced (step S218). When there is another printed sheet to be produced (when a result of step S218 is YES), the image formation device 1 returns to step S210 to repeat the process described above. In contrast, when there is no printed sheet to be produced, the image formation device 1 completes execution of the job (step S219), thereby completing the process.

By following the process described above, when the progress of a job satisfies a predetermined condition, for example when the number of printed sheets produced reaches or exceeds a certain number, or when the number of staples put in sheets reaches or exceeds a certain number during execution of the job, the image formation device 1 can change a billing map to be referred to for billing calculation at that time. For this change, the image formation device 1 of the second preferred embodiment changes only necessary part of the basic billing map 54 that has been referred to since an initial stage of execution of the job. So, a billing map is switched efficiently. Further, the volume of data transmitted from the management server 11 to the image formation device 1 for changing the billing map is reduced, so that a burden on the network 10 can be reduced.

In the second preferred embodiment, when a user uses the image formation device 1 to produce a large number of printed sheets, for example, billing for a printed sheet produced after a certain number of printed sheets were produced, or billing for a staple put in sheets after a certain number of staples were put in sheets, is made at a discount. So, like in the first preferred embodiment, various styles of billing are realized.

### Third Preferred Embodiment

A third preferred embodiment of the present invention is described next. In the above-described first and second preferred embodiments, the image formation device 1 analyzes a job to be executed, and requests the management server 11 to transmit a replacement billing map when a set value of the job exceeds a set value of a predetermined condition. In the third preferred embodiment, the management server 11 keeps track of the progress of a job executed in the image formation device 1, and determines whether or not a replacement billing map should be transmitted to the image formation device 1. The configurations of the image formation system 100, the image formation device 1 and the management server 11 of the third preferred embodiment are basically the same as those of the first and second preferred embodiments, except for features described below.

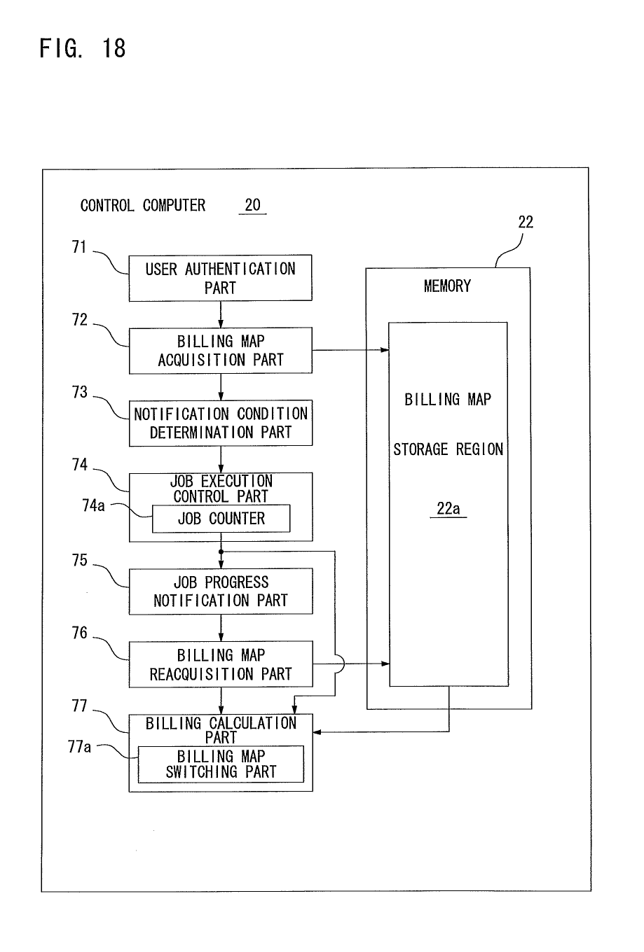

FIG. 18 is a block diagram showing an exemplary functional configuration realized by execution of the program 27 by the control computer 20 of the image formation device 1 in the third preferred embodiment. As shown in FIG. 18, the control computer 20 functions as a user authentication part 71, a billing map acquisition part 72, a notification condition determination part 73, a job execution control part 74, a job progress notification part 75, a billing map reacquisition part 76, and a billing calculation part 77.

The user authentication part 71 and the billing map acquisition part 72 have the same functions as those of the user authentication part 31 and the billing map acquisition part 32 respectively described in the first preferred embodiment.

After starting execution of a job, the image formation device 1 of the third preferred embodiment notifies the management server 11 of the progress of the job. The notification condition determination part 73 determines which condition should be satisfied in order to notify the management server 11 of the progress of the job. In the third preferred embodiment, a basic billing map 54 acquired by the billing map acquisition part 72 from the management server 11 contains information about a notification condition as descried later. So, based on the information about the notification condition contained in the basic billing map 54, the notification condition determination part 73 determines which condition should be satisfied in order to notify the management server 11 of the progress of the job.

The job execution control part 74 has the same function as that of the job execution control part 36 described in the first preferred embodiment, and controls the execution of a job in the image formation device 1. The job execution control part 74 includes a job counter 74a.

The job progress notification part 75 notifies the progress of a job executed by the job execution control part 74 to the management server 11. More particularly, based on a notification condition determined by the notification condition determination part 73, the job progress notification part 75 notifies the management server 11 of the progress of a job each time the progress of the job reaches a set value of the notification condition.

The billing map reacquisition part 76 receives a replacement billing map transmitted from the management server 11, and stores the same into the memory 22. Unlike the billing map reacquisition part 35 of the first preferred embodiment, the billing map reacquisition part 76 does not request the management server 11 to acquire a replacement billing map. The billing map reacquisition part 76 is put on standby to wait for a replacement billing map from the management server 11 after the job execution control part 74 starts execution of a job, and stores the replacement billing map when received into the billing map storage region 22a of the memory 22.

The billing calculation part 77 reads a billing map from the billing map storage region 22a of the memory 22, and performs billing calculation in response to execution of a job by the job execution control part 74. The billing calculation part 77 includes a billing map switching part 77a. The billing map switching part 77a changes a billing map to be referred to for billing calculation when the progress of a job reaches a set value of a predetermined condition. To be more specific, when the billing map reacquisition part 76 already acquired a replacement billing map and stored the same into the memory 22, the billing map switching part 77a of the third preferred embodiment determines whether or not the progress of a job reaches a set value of a predetermined condition based on information contained in the replacement billing map, and changes a billing map.

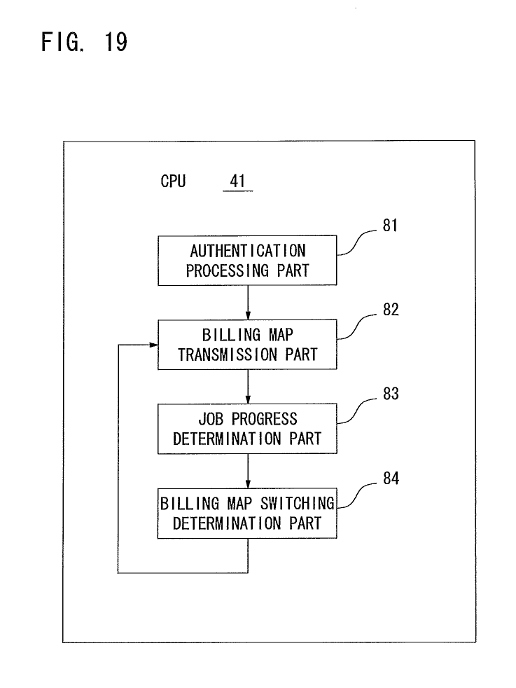

FIG. 19 is a block diagram showing an exemplary functional configuration realized by execution of the program 51 by the CPU 41 of the management server 11 in the third preferred embodiment. As shown in FIG. 19, the CPU 41 becomes operative to function as an authentication processing part 81, a billing map transmission part 82, a job progress determination part 83, and a billing map switching determination part 84.

Like the authentication processing part 61 of the first preferred embodiment, the authentication processing part 81 authenticates a user who uses the image formation device 1.

The billing map transmission part 82 transmits a billing map to be used for billing calculation to the image formation device 1. When the authentication processing part 81 authenticates a user successfully, the billing map transmission part 82 reads the basic billing map 54 from the billing map information 53 stored in the storage part 46, and transmits the same to the image formation device 1. The billing map transmission part 82 also reads a first replacement billing map 55 from the billing map information 53 stored in the storage part 46, and transmits the same to the image formation device 1 when the billing map switching determination part 84 determines that a billing map should be switched. When the billing map switching determination part 84 further determines that a billing map should be switched thereafter, the billing map transmission part 82 reads a second replacement billing map 56 from the billing map information 53 stored in the storage part 46, and transmits the same to the image formation device 1.

When the image formation device 1 starts execution of a job, the job progress determination part 83 determines the progress of the job notified from the job progress notification part 75. The job progress determination part 83 determines the progress of a job in the image formation device 1 based on information given from the job progress notification part 75. Then, the job progress determination part 83 outputs the determined progress of the job to the billing map switching determination part 84.

The billing map switching determination part 84 determines whether or not a billing map should be changed during execution of a job based on the progress of the job in the image formation device 1. When a billing map is to be changed, the billing map switching determination part 84 instructs the billing map transmission part 82 to transmit a replacement billing map to the image formation device 1.

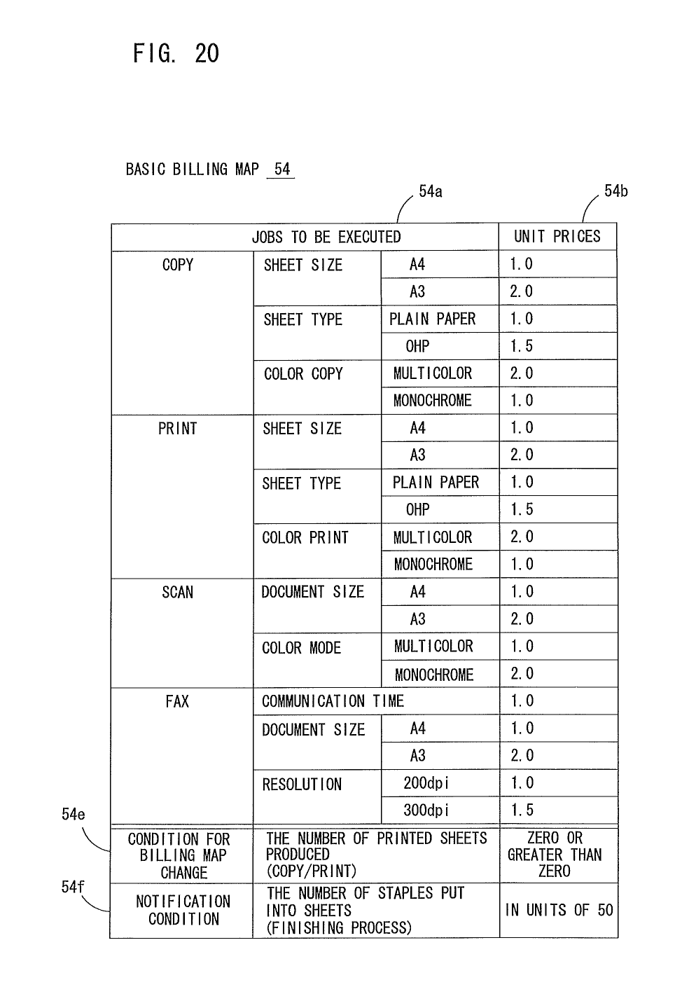

Billing maps contained in the billing map information 53 of the third preferred embodiment are described next. FIG. 20 shows an example of the basic billing map 54 of the third preferred embodiment. As already described, the basic billing map 54 is transmitted to the image formation device 1 immediately after a user has successfully been authenticated. The basic billing map 54 is billing information to be referred to for billing calculation at an initial stage of execution of a job. As shown in FIG. 20, like that of the first preferred embodiment, the basic billing map 54 of the third preferred embodiment contains information 54a about targets of billing of jobs to be executed in the image formation device 1, and unit price information 54b about the targets. The basic billing map 54 of the third preferred embodiment also contains condition information 54e under which the basic billing map 54 is applied for billing calculation. In the example of FIG. 20, the condition information 54e indicates that the basic billing map 54 should be applied when the number of printed sheets produced in a copy job or a print job is zero or greater than zero.

The basic billing map 54 of the third preferred embodiment 54 also contains a notification condition 54f under which the progress of a job is notified to the management server 11 during execution of the job. The job progress notification part 75 of the image formation device 1 notifies the management server 11 of the progress of a job under the notification condition 54f. In the example of FIG. 20, the notification condition 54f indicates that the progress of a job should be notified to the management server 11 each time the count value of the number of printed sheets produced in a copy job or a print job reaches 50.

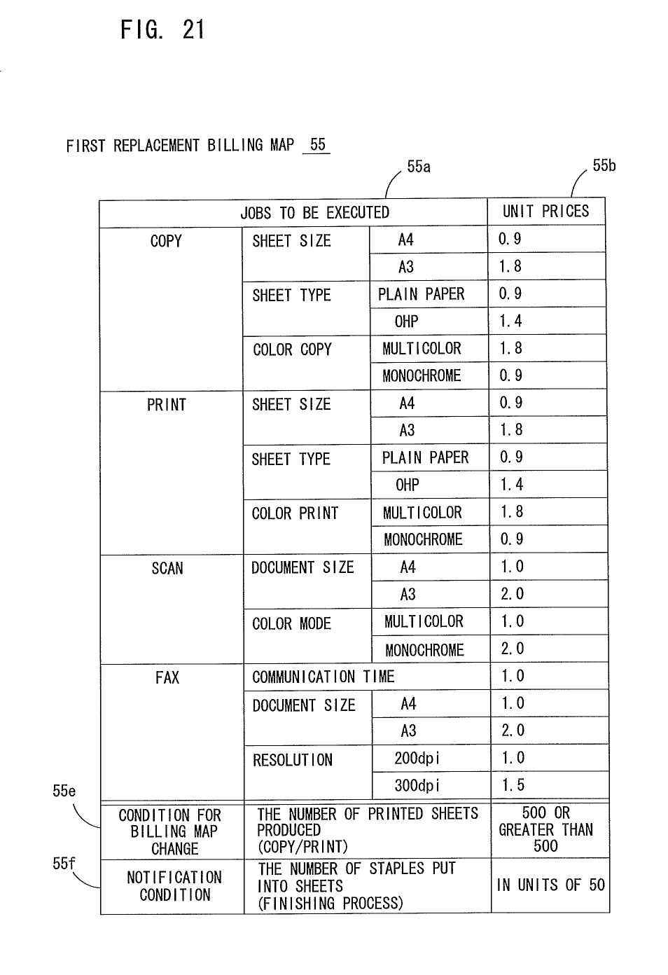

FIG. 21 shows an example of the first replacement billing map 55 of the third preferred embodiment. Like that of the first preferred embodiment, the first replacement billing map 55 of FIG. 21 contains information 55a about targets of billing of jobs to be executed in the image formation device 1, and unit price information 55b about the targets. The first replacement billing map 55 of the third preferred embodiment also contains condition information 55e under which the first replacement billing map 55 is applied for billing calculation. In the example of FIG. 21, the condition information 55e indicates that the first replacement billing map 55 should be applied when the number of printed sheets produced in a copy job or a print job reaches or exceeds 500. So, when the image formation device 1 already acquired the first replacement billing map 55, the billing map switching part 77a of the billing calculation part 77 determines whether or not the basic billing map 54 should be switched to the first replacement billing map 55 based on the condition information 55e contained in the first replacement billing map 55.

The first replacement billing map 55 of the third preferred embodiment 54 also contains a notification condition 55f under which the progress of a job is notified to the management server 11 during execution of the job. After a billing map to be referred to for billing calculation is changed to the first replacement billing map 55, the job progress notification part 75 of the image formation device 1 notifies the management server 11 of the progress of a job based on the notification condition 55f. Like the notification condition 54f in the basic billing map 54, the notification condition 55f in the example of FIG. 21 indicates that the progress of a job should be notified to the management server 11 each time the count value of the number of printed sheets produced in a copy job or a print job reaches 50. So, a frequency with which the progress of a job is notified from the image formation device 1 to the management server 11 does not change after the basic billing map 54 of FIG. 20 is changed to the first replacement billing map 55 of FIG. 21.

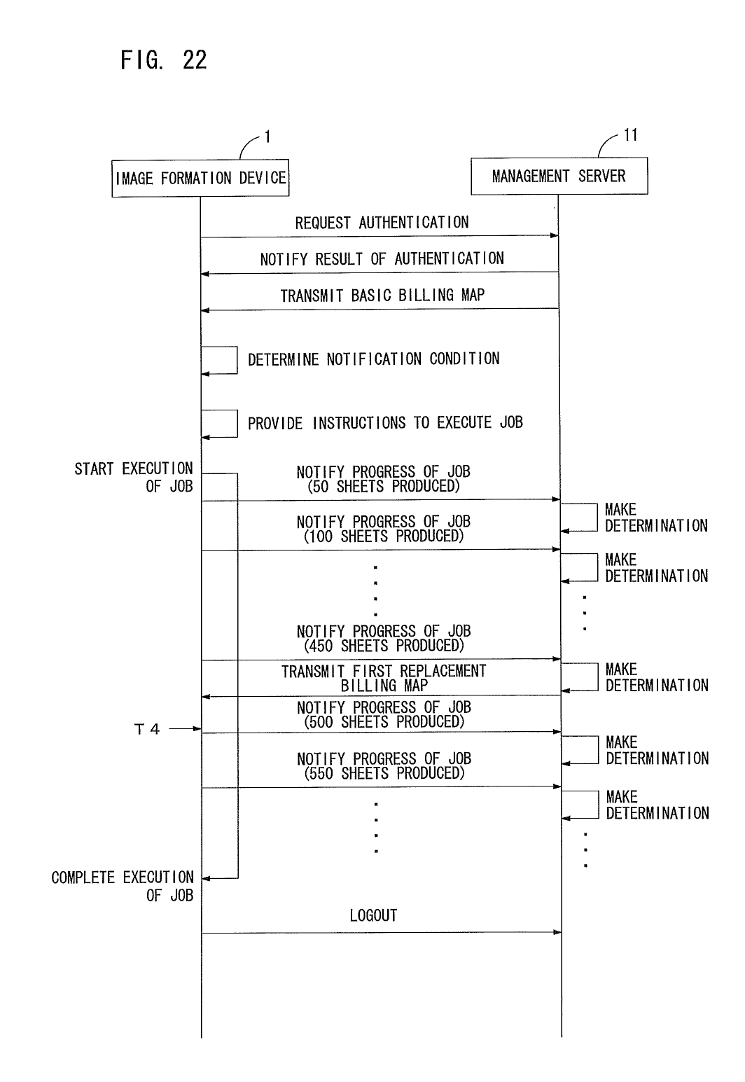

The general outlines of processes performed by the image formation device 1 and the management server 11 of the third preferred embodiment are described next with reference to FIG. 22. First, the image formation device 1 transmits a request for authentication to the management server 11. On receipt of the request for authentication, the management server 11 authenticates a user, and transmits a result of the authentication to the image formation device 1. When the result of the authentication is to notify that the user has successfully been authenticated, the management server 11 reads the basic billing map 54 from the billing map information 53, and transmits the same to the image formation device 1.

On receipt of the result of the authentication notifying that the user has successfully been authenticated from the management server 11, the image formation device 1 is switched to a state where the authenticated user has logged in to the image formation device 1. Next, the image formation device 1 receives the basic billing map 54 from the management server 11. When the login user makes various setting operations and the like and provides instructions to execute a job thereafter, the image formation device 1 starts execution of the job. The image formation device 1 performs billing calculation based on the basic billing map 54 in response to execution of the job.

After starting execution of the job, the image formation device 1 notifies the management server 11 of the progress of the job based on the notification condition 54f contained in the basic billing map 54. In this example, the image formation device 1 notifies the management server 11 of the progress of the job each time the number of printed sheets produced reaches 50.

Each time the progress of the job is received from the image formation device 1, the management server 11 checks on the received progress, and determines whether or not the first replacement billing map 55 should be transmitted. When the progress of the job approaches a set value of the condition under which the first replacement billing map 55 is applied, the management server 11 transmits the first replacement billing map 55 to the image formation device 1. In the example of FIG. 22, when the progress of the job is such that the number of printed sheets produced reaches 450, the management server 11 transmits the first replacement billing map 55 to be applied for a five-hundredth printed sheet and its subsequent printed sheets produced.

When receiving the first replacement billing map 55 from the management server 11, the image formation device 1 checks on the condition information 55e contained therein. Then, at a time T4 at which the progress of the job is such that the number of printed sheets produced reaches 500, the image formation device 1 replaces the basic billing map 54 with the first replacement billing map 55 to be referred to for billing calculation after the time T4. The image formation device 1 thereafter performs billing calculation based on the first replacement billing map 55. Billing calculation is completed as a result of completion of execution of the job. When the login user makes a logout operation thereafter, the image formation device 1 notifies the management server 11 of the logout of the login user.

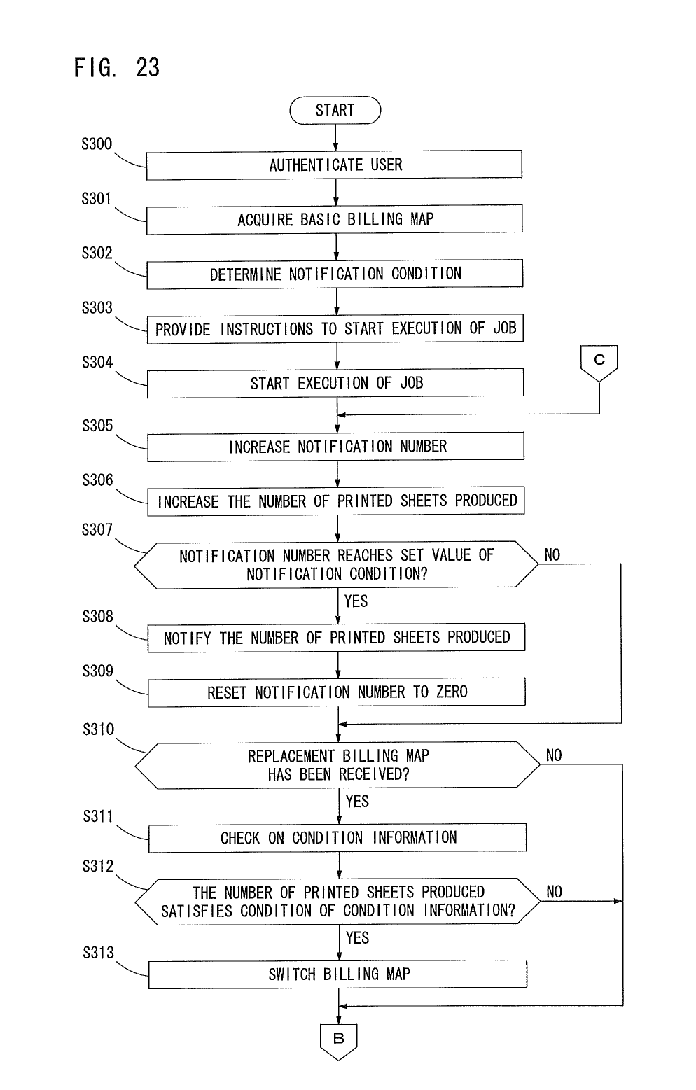

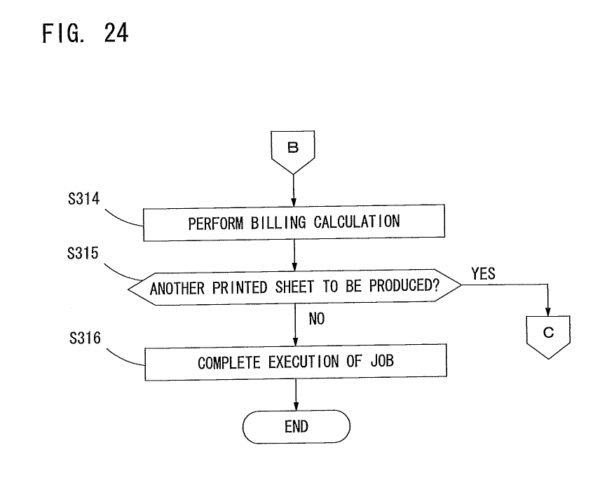

FIGS. 23 and 24 are flow diagrams explaining an exemplary procedure of a process performed by the image formation device 1 in the third preferred embodiment. The image formation device 1 authenticates a user (step S300), and acquires the basic billing map 54 from the management server 11 (step S301) when the user has successfully been authenticated. Next, based on the notification condition 54f contained in the acquired basic billing map 54, the image formation device 1 determines which condition should be satisfied in order to notify the management server 11 of the progress of a job (step S302). Then, in response to instructions provided by the user to start execution of the job (step S303), the image formation device 1 starts execution of the job (step S304), by which printed sheets are produced by one by for example by the printer section 3 in the image formation device 1.

Next, the image formation device 1 counts up a notification number as a result of production of the most recent printed sheet (step S305). This notification number is counted to determine whether or not a set value of the condition defined by the notification condition 54f is reached. The image formation device 1 thereafter counts up the number of printed sheets produced to incorporate production of the most recent printed sheet (step S306).

Next, the image formation device 1 determines whether or not the notification number reaches the set value of the condition defined by the notification condition 54f (step S307). When the notification number reaches the set value, the image formation device 1 notifies the management server 11 of the current number of printed sheets produced as the progress of the job (step S308). After notifying the management server 11 of the number of printed sheets produced, the image formation device 1 resets the count value of the notification number to zero (step S309). In contrast, when the notification number does not reach the set value of the condition defined by the notification condition 54f, steps S308 and 5309 are not performed. By following steps S307 to 5309 in the image formation device 1, the current number of printed sheets produced is notified from the image formation device 1 to the management server 11 each time the number of printed sheets produced reaches 50, for example.

The image formation device 1 thereafter determines whether or not the first replacement billing map 55 has already been acquired from the management server 11 (step S310). When the first replacement billing map 55 has already been acquired, the image formation device 1 checks on the condition information 55e in the first replacement billing map 55 to see the condition under which the first replacement billing map 55 is applied (step S311). Then, the image formation device 1 determines whether or not the current number of printed sheets produced satisfies the condition defined by the condition information 55e (step S312). When the current number satisfies the condition, the image formation device 1 switches a billing map (step S313), namely replaces the basic billing map 54 with the first replacement billing map 55. In contrast, when the first replacement billing map 55 has not been received yet (when a result of step S310 is NO), or when the current number of printed sheets produced does not satisfy the condition defined by the condition information 55e (when a result of step S312 is NO), the image formation device 1 does not switch a billing map.

Referring next to the flow diagram of FIG. 24, the image formation device 1 performs billing calculation in response to the above-described production of the most recent printed sheet (step S314). This billing calculation uses the basic billing map 54 until switching of a billing map in step S313, and uses the first replacement billing map 55 after it takes the place of the basic billing map 54 in step S313.

Next, the image formation device 1 determines whether or not there is another printed sheet to be produced (step S315). When there is another printed sheet to be produced (when a result of step S315 is YES), the image formation device 1 returns to step S305 of FIG. 23 to repeat the process described above. In contrast, when there is no printed sheet to be produced, the image formation device 1 completes execution of the job (step S316), thereby completing the process.

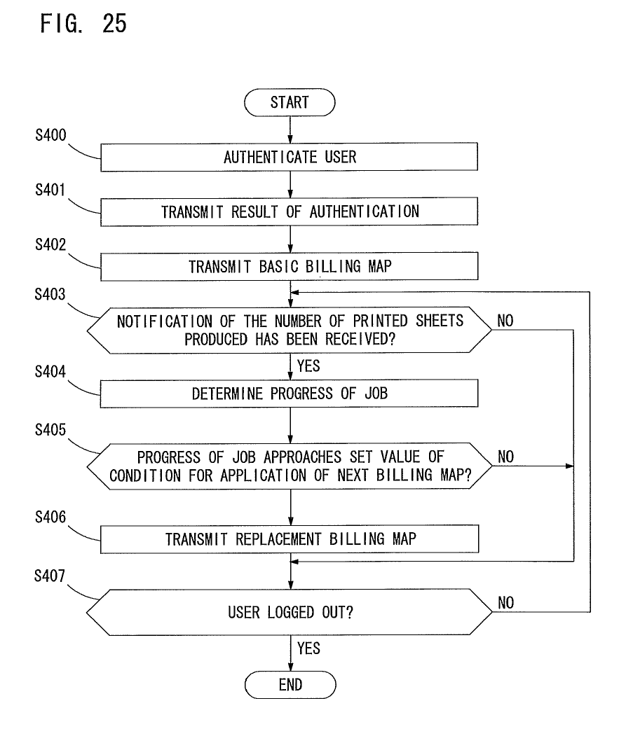

FIG. 25 is a flow diagram explaining an exemplary procedure of a process performed by the management server 11 in the third preferred embodiment. The management server 11 authenticates a user in response to a request from the image formation device 1 (step S400), and transmits a result of authentication to the image formation device 1 (step S401). When the user has successfully been authenticated, the management server 11 reads the basic billing map 54 from the storage part 46, and transmits the same to the image formation device 1 (step S402).

After transmitting the basic billing map 54, the management server 11 determines whether of not a notification of the number of printed sheets produced has been received from the image formation device 1 (step S403). When receiving the notification of the number of printed sheets produced, the management server 11 determines the progress of a job in the image formation device 1 based on the notification (step S404), and determines whether or not the progress of the job approaches a set value of a condition under which a next billing map is applied (step S405). By way of example, when the number of remaining printed sheets, that are to be produced before application of the next billing map, is not greater than a predetermined number, the management server 11 determines that the progress of the job approaches the set value of the condition under which the next billing map is applied. When the progress of the job approaches the set value of the condition, the management server 11 reads the first replacement billing map 55 from the storage part 46, and transmits the same to the image formation device 1 (step S406). In contrast, when the management server 11 has not received the notification of the number of printed sheets produced from the image formation device 1 (when a result of step S403 is NO), or when the progress of the job does not approach the set value of the condition under which the next billing map is applied (when a result of step S405 is NO), the management server 11 does not transmit the first replacement billing map 55.

The management server 11 thereafter determines whether the user has logged out (step S407). When the user still logs in, the management server 11 returns to step S403 to repeat the process described above. When the user has logged out, the management server 11 completes the process.

By following the process described above, while keeping track of the progress of a job in the image formation device 1, the management server 11 transmits the replacement billing map 55, which is to take the place of the basic billing map 54 transmitted after user authentication, to the image formation device 1 when the progress of the job comes close to reaching a set value of a predetermined condition. Thus, in the third preferred embodiment, the image formation device 1 is not required to analyze a job before starting execution of the job. This reduces a processing burden on the image formation device 1.

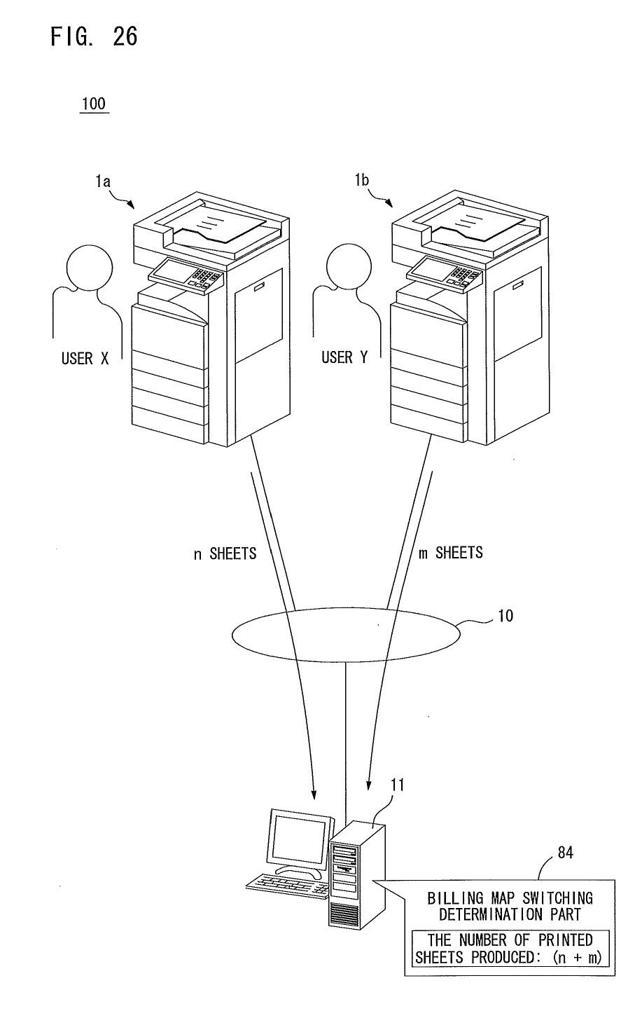

As already described, the management server 11 determines whether or not a billing map should be changed in the image formation device 1, by which an exemplary billing style described next is realized. More specifically, when a plurality of users belonging to the same section simultaneously use a plurality of image formation devices 1 connected to the network 10, the numbers of printed sheets produced by these users are added together, and calculation of billing is performed at a discount for a total number. FIG. 26 explains such a billing style, and shows a configuration in which a plurality of image formation devices 1a and 1b are connected to the network 10.

It is assumed as shown in FIG. 26 that a user X uses the image formation device 1a and a user Y belonging to the same section as the user X uses the image formation device 1b. The image formation devices 1a and 1b perform billing calculations in response to execution of jobs based on billing maps transmitted from the management server 11, and transmit the progresses of the respective jobs to the management server 11. In the example of FIG. 26, the current number of printed sheets produced in the image formation device 1a is n (n is an integer of not less than 1), and the current number of printed sheets produced in the image formation device 1b is m (m is an integer of not less than 1). In order to determine whether or not a billing map should be changed, the billing map switching determination part 84 of the management server 11 determines whether or not a total of count of the jobs (n+m) simultaneously executed in the image formation devices 1a and 1b satisfies a predetermined condition. When the total count satisfies the predetermined condition, the management server 11 transmits each of the image formation devices 1a and 1b to transmit a replacement billing map to be referred to for billing calculation.

In this case, by simultaneous use of the image formation devices 1a and 1b by the users X and Y respectively belonging to the same section, calculation of billing can be performed at a discount in response to a state of use of the image formation device 1 in each section. So, billing for using the image formation device 1 is made in various styles, by which billing styles responsive to various needs are realized.

Like in the second preferred embodiment, when transmitting the replacement billing map 55 to the image formation device 1 (1a, 1b) in the third preferred embodiment, the management server 11 may transmit information corresponding to only part of the basic billing map 54.

### (Modifications)

While the preferred embodiments of the present invention have been described above, the present invention is not intended to be confined to the details shown above.

In the above-described preferred embodiments, a condition under which a billing map is changed is set in response to the number of sheets to be produced or the number of staples to be put in sheets as a result of execution of a job. However, this is not the only example of setting a condition under which a billing map is changed. As another example, the amount of toner consumed as a result of execution of a job in the image formation device 1 may be calculated, and a condition under which a billing map is changed may be set in response to the amount of toner to be consumed. That is, a condition under which a billing map is changed is required to be set with respect to at least one of the number of printed sheets to be produced, the number of staples to be put in sheets, and the amount of toner to be consumed. As other examples, a condition under which a billing map is changed may be set with respect to the number of sheets to be scanned, the number of sheets to be faxed, the number of sheets to be transmitted to the outside, a period of time to be required for transmission to the outside, or various conditions concerning downloading of image data using a Web browser function.

In the above-described preferred embodiments, an object of changing a billing map during execution of a job is to bill a user at a discount. However, making a discount is not the only object of changing a billing map.

In the above-described preferred embodiments, a billing map is changed during execution of mainly a one-time job, to which the present invention is not intended to be confined. As an example, when the image formation device 1 executes a job with a user logging in to the image formation device 1, the accumulated total of count values such as those of the number of printed sheets produced or of the number of staples put in sheets may be obtained. So, even when a job is executed several times, a billing map may be changed when the several jobs satisfy a predetermined condition. If the accumulated total of the count values is held for a certain period of time, a billing map may be changed when monthly usage satisfies a predetermined condition, for example.

In the above-described preferred embodiments, the image formation device 1 acquires a billing map from the management server 11, to which the present invention is not intended to be confined. By way of example, the image formation device 1 itself may have part of or all of the function of the management server 11 described above.

While the invention has been shown and described in detail, the foregoing description is in all aspects illustrative and not restrictive. It is therefore understood that numerous modifications and variations can be devised without departing from the scope of the invention.

What is claimed is:

1. An image formation system comprising an image formation device and a management server connected through a network in a manner that allows data communication with each other,
said management server including:
a storage part for storing therein billing map information to be referred to for billing calculation in response to execution of a job in said image formation device; and
a billing map transmission part for reading a billing map to be transmitted to said image formation device that is one of a plurality of billing maps contained in said billing map information, and for transmitting the read billing map to said image formation device,
said image formation device including:
a billing map acquisition part for acquiring the billing map transmitted from said management server;
a job execution control part for controlling execution of a job;
a billing calculation part for performing billing calculation by referring to the billing map acquired by said billing map acquisition part in response to execution of said job by said job execution control part; and
a billing map switching part for changing the billing map to be referred to by said billing calculation part when the progress of said job executed by said job execution control part satisfies a predetermined condition.

2. The image formation system according to claim 1, wherein
information about said predetermined condition is contained in said billing map acquired by said billing map acquisition part from said management server.

3. The image formation system according to claim 1, wherein
said billing map transmission part transmits a basic billing map and a replacement billing map to said image formation device, said basic billing map being referred to for billing calculation at an initial stage of execution of a job in said image formation device, said replacement billing map taking the place of said basic billing map when the progress of said job in said image formation device satisfies said predetermined condition, and
said billing map switching part changes the billing map to be referred to by said billing calculation part from said basic billing map to said replacement billing map when said progress of said job executed by said job execution control part satisfies said predetermined condition.

4. The image formation system according to claim 3, wherein
said image formation device further includes:
a determination part for analyzing the substance of said job to be executed by said job execution control part, and for determining whether or not said job satisfies said predetermined condition; and
a billing map reacquisition part for acquiring said replacement billing map by requesting said management server to transmit said replacement billing map when said determination part determines that said job satisfies said predetermined condition, and
said billing map switching part changes the billing map to be referred to by said billing calculation part to said replacement billing map acquired by said billing map reacquisition part when the progress of said job executed by said job execution control part satisfies said predetermined condition.

5. The image formation system according to claim 3, wherein
said replacement billing map transmitted from said billing map transmission part contains information with which part of said basic billing map is rewritten.

6. The image formation system according to claim 1, wherein
said image formation device further includes a job progress notification part for notifying said management server of the progress of said job in response to execution of said job by said job execution control part,
said management server further includes a billing map switching determination part for determining whether or not the billing map to be referred to by said billing calculation part should be changed during execution of said job based on said progress of said job notified from said image formation device, and
after transmitting a basic billing map to be referred to for billing calculation at an initial stage of execution of said job in said image formation device, said billing map transmission part transmits a replacement billing map to take the place of said basic billing map to said image formation device when said billing map switching determination part determines that the billing map should be changed.

7. The image formation system according to claim 3, wherein
said image formation device further includes a job progress notification part for notifying said management server of the progress of said job in response to execution of said job by said job execution control part,
said management server further includes a billing map switching determination part for determining whether or not the billing map to be referred to by said billing calculation part should be changed during execution of said job based on said progress of said job notified from said image formation device, and
after transmitting said basic billing map, said billing map transmission part transmits said replacement billing map to said image formation device when said billing map switching determination part determines that the billing map should be changed.

8. The image formation system according to claim 1, wherein
said predetermined condition is set with respect to at least one of the number of printed sheets to be produced, the number of staples to be put in sheets, and the amount of toner to be consumed as a result of execution of a job.

9. An image formation system comprising a first image formation device, a second image formation device, and a management server connected through a network in a manner that allows data communication with each other,
each of said first and second image formation devices including:
a billing map acquisition part for acquiring a billing map transmitted from said management server through said network;
a billing calculation part for performing billing calculation based on said billing map in response to execution of a job; and
a job progress notification part for notifying said management server of the progress of said job,
said management server including:
a billing map transmission part for transmitting a basic billing map to each of said first and second image formation devices, said basic billing map being used for billing calculation at an initial stage of execution of a job; and
a billing map switching determination part for determining, after transmission of said basic billing map, whether or not the respective progresses of two or more jobs executed in said first and second image formation devices satisfy a predetermined condition based on said respective progresses of said jobs notified both from said first and second image formation devices, wherein
said billing map transmission part transmits a replacement billing map to take the place of said basic billing map to each of said first and second image formation devices based on a result of the determination made by said billing map switching determination part.

10. An image formation device, comprising
a job execution control part for controlling execution of a job;
a storage part for storing therein a billing map to be used for billing calculation in response to execution of said job;
a billing calculation part for performing billing calculation by referring to the billing map stored in said storage part in response to execution of said job by said job execution control part; and
a billing map switching part for changing the billing map to be referred to by said billing calculation part when the progress of said job executed by said job execution control part satisfies a predetermined condition.

11. The image formation device according to claim 10, wherein
said storage part stores therein a basic billing map and a replacement billing map, said basic billing map being referred to for billing calculation at an initial stage of execution of a job, said replacement billing map taking the place of said basic billing map when the progress of said job satisfies said predetermined condition, and
said billing map switching part changes the billing map to be referred to by said billing calculation part from said basic billing map to said replacement billing map when said progress of said job executed by said job execution control part satisfies said predetermined condition.

12. The image formation device according to claim 10, further comprising:
a network interface for establishing data communication with a management server through a network;
a billing map acquisition part for acquiring a basic billing map being referred to for billing calculation at an initial stage of execution of a job from said management server through said network interface, and for storing said basic billing map into said storage part;
a determination part for analyzing the substance of a job to be executed by said job execution control part, and for determining whether or not said job satisfies said predetermined condition; and
a billing map reacquisition part for acquiring a replacement billing map taking the place of said basic billing map from said management server through said network interface, and for storing said acquired replacement billing map into said storage part when said determination part determines that said job satisfies said predetermined condition.

13. The image formation device according to claim 11, further comprising:
a network interface for establishing data communication with a management server through a network;
a billing map acquisition part for acquiring said basic billing map transmitted from said management server through said network interface, and for storing said basic billing map into said storage part;
a determination part for analyzing the substance of a job to be executed by said job execution control part, and for determining whether or not said job satisfies said predetermined condition; and
a billing map reacquisition part for acquiring said replacement billing map from said management server by requesting said management server to transmit said replacement billing map through said network interface, and for storing said replacement billing map into said storage part when said determination part determines that said job satisfies said predetermined condition.

14. A method of billing calculation performed in response to execution of a job in an image formation device, comprising the steps of:
acquiring a basic billing map and a replacement billing map before execution of a job, said basic billing map being used for billing calculation at an initial stage of execution of said job, said replacement billing map being used for billing calculation at a stage at which the progress of said job satisfies a predetermined condition;
starting execution of said job;
performing billing calculation based on said basic billing map in response to execution of the started job;
changing the billing map to be referred to for said billing calculation from said basic billing map to said replacement billing map when said progress of said job satisfies said predetermined condition; and
after said progress of said job satisfies said predetermined condition, performing billing calculation based on said replacement billing map in response to execution of said job.
